(19) United States
(12) Patent Application Publication
(10) Pub. No.: US 2017/0316459 A1
(43) Pub. Date: Nov. 2, 2017

(54) DATA SYSTEM FOR ADAPTIVE INCENTIVE ALLOCATION IN AN ONLINE NETWORKED ENVIRONMENT

(71) Applicant: TrueCar, Inc., Santa Monica, CA (US)

(72) Inventors: Oliver Thomas Strauss, Santa Barbara, CA (US); Daniel J. Malik, Sierra Madre, CA (US); Deward Andrew Watts, Manhattan Beach, CA (US); Russell Alan Foltz-Smith, Marina Del Rey, CA (US)

(21) Appl. No.: 15/582,301

(22) Filed: Apr. 28, 2017

Related U.S. Application Data
(60) Provisional application No. 62/329,099, filed on Apr. 28, 2016.

(51) Int. Cl. G06Q 30/02; G06Q 10/06

(52) U.S. Cl. CPC G06Q 30/0255; G06Q 30/0269; G06Q 10/067; G06Q 30/0202; G06Q 30/0206

(57) ABSTRACT

A data system can maintain a targeted incentive database mapping product categories to targeted incentive levels and mapping the targeted incentive levels to a plurality of user segments corresponding to observable features of users. The data system can receive a user query from a user computer device, the query comprising product configuration information, apply a set of segment matching rules to match the user to a user segment from the targeted incentive database based on a set of observable features associated with the user, identify a targeted incentive level for a product category from a plurality of targeted incentive levels for the product category according to a mapping between the determined user segment and the identified targeted incentive level in the targeted incentive database and generate a responsive web page to display the identified targeted incentive level at the user computing device.

### RELATED APPLICATIONS

This application claims the benefit of priority under 35 U.S.C. §119 to U.S. Provisional Patent Application Ser. No. 62/329,099 filed on Apr. 28, 2016, by Oliver Thomas Strauss, entitled “Adaptive Incentive Allocation Systems and Methods Using Behavioral Analytics”, which is fully incorporated herein by reference for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates generally to online data collection and processing in a distributed and heterogeneous computer network environment. More particularly, this disclosure generally relates to systems and methods for rules based incentive provisioning to provide targeted incentives in real-time with increased accuracy and resolution. Even more particularly, some embodiments disclosed herein relate to adaptive incentive provisioning using behavioral analytics.

### BACKGROUND

Currently, there are a number of online vehicle data systems that attempt to distribute certain vehicle data over an online network (e.g., Internet, cellular network, etc.) to facilitate vehicle purchasing. Some of these systems provide vehicle pricing information containing pricing that will be honored by an affiliated dealer. Vehicle prices, however, are dependent on a number of factors including incentives offered by dealers and automobile original equipment manufacturers (OEM) to influence purchasing decisions (e.g., to generate sales, achieve sales targets). Incentives may take many forms. For example, an automobile manufacturer may provide discounts off the Manufacturer's Suggested Retail Price (MSRP), financing or lease discounts, complimentary accessories, or free maintenance. Conventional online vehicle data systems, however, suffer a number of shortcomings for providing incentives.

These inadequacies stem from a number of deficiencies that can be grouped at a high level into two interrelated categories: the ability to both 1) allocate incentives in real-time over such online networks (i.e., at a speed at which a user of those online networks would expect a response under typical conditions), and 2) ensure that the incentives are accurately and efficiently allocated to users. Online vehicle data systems have been forced (at least by ever-increasing user expectations regarding the speed of such online networks) to attend primarily to the first concern.

OEMs typically release incentives as undifferentiated discounts regardless of market, buyer, seller, or to a limited extent, incentives redeemable by a large group of users, such as current owners of an OEM vehicles. Historically, OEMs determine incentives by analyzing the number of units sold and using budgets often, if not exclusively, pulled from annual marketing budgets. While an OEM's marketing budget may be spread across different audiences, a marketing budget does not accurately reflect the effects of pricing changes. More particularly, the impact to sales performance of a price change cannot be measured from a marketing budget and must be inferred by experienced marketers. These inferences, however, lack differentiated vehicle pricing and thus do not provide a price signal. Consequently, sales targets and incentive amounts are often defined manually, based on an ad hoc subjective analysis of the marketing budget. As the resulting analysis is confined to only limited data, the resulting analysis does not provide an accurate and complete picture of the effects of incentives of incentives on consumer behavior, particularly in the context of particular consumer groups, and leads to an inefficient allocation of incentives. Moreover, the analysis is time consuming. Consequently, OEMs release incentives without regard to up to date data on a time scale of months or years. By the time the incentives or are released or during the lifetimes of the incentives, the data on which they are based may become obsolete. Moreover, the long time scale of incentives can lead to a prolonged inefficient allocation of incentives.

While some online vehicle data systems may present incentives to users, these incentives are typically just digital versions of incentives determined by OEMs as discussed above. These online systems typically make the same incentives available to every user who accesses certain pages. If an incentive is only redeemable by members of a particular group (e.g., current owners of an OEM vehicle), the incentive is still presented to all users who access the page(s) in which the incentive is included, and it is the dealer who closes the sale that is responsible for determining whether a consumer qualifies for the incentive when the consumer goes to the dealership to finalize a purchase. Due to the large number of users who may use the online vehicle data system, and the long time scales for which incentives are available, current online vehicle data systems provide an untargeted and low fidelity approach that exacerbates the inefficiencies of incentive allocation.

### SUMMARY OF THE DISCLOSURE

Embodiments described herein can provide a data system, such as a vehicle data system, and related to provide targeted incentives to users. Incentives may be targeted using behavioral analytics. One embodiment of a data system can include a targeted incentive database mapping product categories to targeted incentive levels and mapping the targeted incentive levels to a plurality of user segments corresponding to observable features of users. The system can further include a processor and a non-transitory computer readable medium storing instructions that are translatable by the processor to provide an interface for an online product search service, receive a user query from a user computer device, the query comprising product configuration information, collect a set of observable features associated with the user, apply a set of segment matching rules to match the user to a user segment from the targeted incentive database based on the set of observable features associated with the user, identify a targeted incentive level for a product category from a plurality of targeted incentive levels for the product category according to a mapping between the determined user segment and the identified targeted incentive level in the targeted incentive database and generate a responsive web page to display the identified targeted incentive level at the user computing device. Generating the responsive web page to display the identified targeted incentive level may include generating an incentive that includes a unique code so that the certificate can be verified at a later time.

In accordance with one aspect, the system may record user behavior with the online product search service in a usage log containing activities associated with the user. The set the set of observable features associated with the user and used to determine a segment can include the user behavior. The user behavior may comprise a sequence of search queries made and items viewed.

According to one embodiment, a first user segment can be defined based on a first type of user behavior and second user segment can be defined based on a second type of user behavior. The first type of user behavior and second type of user behavior may represent different levels of searching. For example the first type user behavior may correspond to the user searching by brand while the second type of user behavior may correspond to the user searching by model. Furthermore, a first incentive level for a product category can be associated with the first user segment and a second incentive level for the product category can be associated with the second segment. Thus, different users may receive different incentives associated with the product category based the users' respective behaviors.

The system can be configured to obtain a set of historical data from a plurality of data sources, identify a first vehicle model and a set of competitive vehicle models and develop a demand model for the first vehicle model based on a multivariable analysis of a set of vehicle pricing data, vehicle incentive data, and historical transaction records, the demand model defining demand as function of first vehicle model price and vehicle model prices of vehicle models in the set of competitive vehicle models.

The system may further determine a price elasticity of demand for the first vehicle model based on determining the change in demand for a change in a first vehicle model price using the demand model. The price elasticity of demand for the first vehicle model can be applied to a first set of incremental changes in the first vehicle model price to determine the demand response for the first set of incremental changes in the first vehicle model price. The first set of incremental changes in the first vehicle model price can correspond to different incentive amounts applied to the first vehicle model price. The system may persist, in the targeted incentive database, a first set of incentive levels for the first vehicle model where the first set of incentive levels are associated with the plurality of incentive amounts.

The system may further determine a cross price elasticity of demand for the first vehicle model based on determining a change in demand for a change in a second vehicle model price using the demand model, where the second vehicle model is selected from the set of competitive vehicle models. The cross price elasticity of demand for the first vehicle model may be applied to a set of incremental changes in the second vehicle model price to determine the demand response for the incremental changes in the second vehicle model price. The incremental changes in the second vehicle model price may correspond to a plurality of incentive amounts applied to the second vehicle model price.

The system may further determine a set of user segments based on similarities between user features. For a selected segment from the set of user segments, the system may determine a segment specific demand response for a second set of incremental changes in the first vehicle model price, the second set of incremental changes in the first vehicle model price may correspond to a second set of incentive amounts applied to the first vehicle model price. The system may persist, in the targeted incentive database, at least one incentive level for the first vehicle associated with the selected segment and at least one of the second set of incentive amounts.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings in which like reference numbers indicate like features.

FIG. 1 is a diagrammatic representation of an embodiment of a vehicle data system operating in a network environment.

FIG. 2 is a diagrammatic representation of an embodiment of a vehicle data system operating in a network environment.

FIG. 3 depicts one embodiment of a targeted incentive data set.

FIG. 4 is a diagrammatic representation illustrating one embodiment of providing targeted incentives based on his or her behavior.

FIG. 5 is a diagrammatic representation of one embodiment of a system for optimizing targeted incentives.

FIG. 6A and FIG. 6B depict an example data set for a vehicle.

FIG. 6C and FIG. 6D depict and example data set for a competitive set of vehicles.

FIG. 7A depicts one embodiment of a demand response data set.

FIG. 7B depicts one embodiment of a response in demand based on competitive vehicle pricing data set.

FIG. 8A is a diagrammatic representation of an offline process in accordance with some embodiments.

FIG. 8B is a diagrammatic representation of an online process in accordance with some embodiments.

FIG. 8C is a diagrammatic representation of another example of an online process in accordance with some embodiments.

FIG. 9A is a diagrammatic representation of one embodiment of a system performing an offline process in accordance with some embodiments.

FIG. 9B is a diagrammatic representation of one embodiment of a system performing an offline process in accordance with some embodiments.

FIG. 9C is a diagrammatic representation of one embodiment of a system performing another offline process in accordance with some embodiments.

FIG. 10 depicts a flowchart of an update process in accordance with some embodiments.

FIG. 11 depicts a diagrammatic representation of an update process in accordance with some embodiments.

FIG. 12A illustrates one embodiment of a web interface for a vehicle data system that allows a user to search vehicle data.

FIG. 12B illustrates one embodiment of a web interface for a vehicle data system displaying targeted content.

FIG. 13 illustrates another embodiment of a web interface for a vehicle data system displaying targeted content.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. For example, though embodiments of the invention have been presented using the example commodity of vehicles, it should be understood that other embodiments may be equally effectively applied to other commodities.

As discussed above, providing incentives to users of typically a low fidelity, inefficient process. According the present disclosure, a data system, such as a vehicle data system, and related methods are provided to allocate targeted incentives to users. The data system according to one embodiment may be communicatively connected to a user device, a data store, and at least one data source. A particular user may send a query which may be received by the system. The system may determine an incentive for the particular user based on a set of observable features associated with the user and present the determined incentive to the particular user.

The system may further obtain data from one or more data sources, determine an incentive for one or more user segments and persist the determined incentives, such as in a table on the data store. Incentives may be determined based on a demand model that incorporates a number of factors such as sales targets, buyer profile (including demographics [e.g., age, income, gender], previous buying behavior, cross-shop behavior), geography, intent, response rates, affiliation with trusted non-automotive brands, level of interest in different vehicle models, location, market factors (macro-economic factors), industry-specific factors (e.g., inventory of vehicles), vehicle/model specific attributes (e.g., gas mileage, horsepower, content, lifecycle). Systems and methods described herein may determine incentives for a product on a per-user segment basis on any time scale. As such, the determined incentives may be specific to both user groups and product configurations, such as makes/models of vehicle.

Over time, it may be desired to update the determined incentives. An update process may receive or obtain data from one or more sources. The system may determine whether to update the incentives. If the system determines that the incentives should be updated, the system may determine updated incentives and persist the updated incentives. Numerous other embodiments are also possible.

Further, systems and methods described herein may be used to analytically predict sales and recommend changes in incentives based on various incentive levels. A system as described herein may also be used to customize incentive spending amounts for customers, thus optimizing OEM and dealer costs of incentive spending.

Incentive levels may be presented to a user in response to a query for a product or service on a website. In this disclosure, a user can be a website visitor of an intermediate website who is or potentially is a customer of an affiliate of the intermediate website. For example, an affiliate may represent a dealership owned and operated by an entity independently of the intermediate website and having a contractual relationship with the operator of the intermediate website. For this reason, “user” and “customer” are used interchangeably in this disclosure.

Users searching for a vehicle (e.g., on a website) may be given various incentive levels based on their behavior. For example, a user searching for a specific make and model of a vehicle may be placed in a first category. This user may be offered one level of incentive for the specific vehicle searched because, for example, it may be assumed that the user already has decided which model to purchase or is strongly interested in that model. A user searching by only brand or price, however, may be offered a second, different incentive level because, for example, the user may be undecided on which model to purchase. Yet a third incentive level may be given to a user searching for a competitive make and/or model.

Additionally, in some embodiments, a user may download an incentive certificate for a first vehicle from a first brand, which may be redeemable at one or more locations. The incentive may be specific to a make, model, trim level, option, or even VIN number. A competing brand may offer an incentive to the user that downloaded the certificate, for example, to try and persuade the user to choose the competing brand over the first brand. The competing brand incentive may be greater than the incentive of the downloaded certificate. The competing brand incentive may be a fourth incentive level, the fourth incentive level higher than would have been offered to the user prior to downloading the incentive certificate for the first brand. Additional incentive offers may be sent to a user based on other events. For example, a user may be offered a higher incentive after a specified time period after a certificate is downloaded.

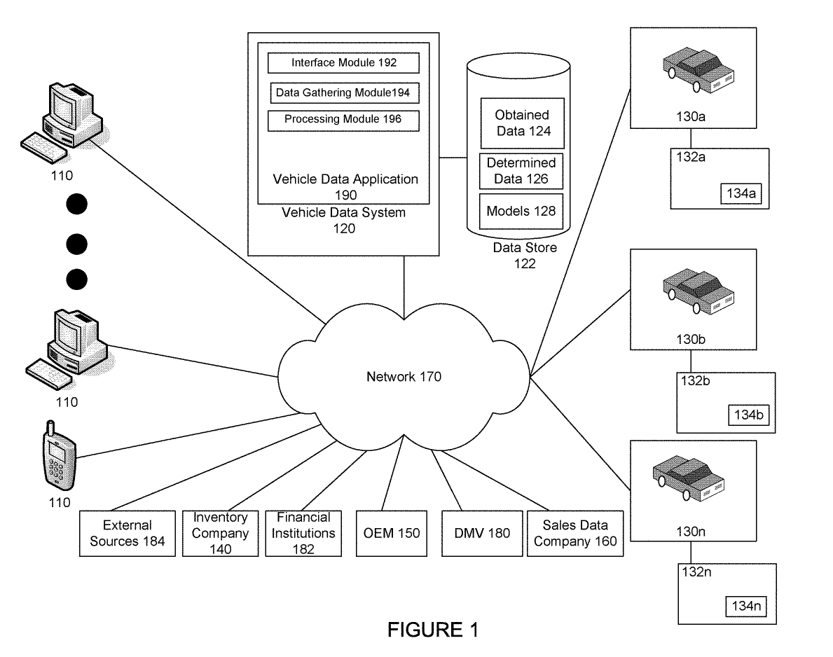

Embodiments of the systems and methods of the invention may be better explained with reference to FIG. 1 which depicts an example topology 100 which may be used to implement embodiments of the systems and methods of the invention. Additional example topologies can be found in U.S. Pat. No. 9,129,325, issued Sep. 8, 2015, entitled “SYSTEM AND METHOD FOR AGGREGATION, ANALYSIS, PRESENTATION AND MONETIZATION OF PRICING DATA FOR VEHICLES AND OTHER COMMODITIES,”, U.S. Pat. No. 7,945,483, issued May 17, 2011, entitled “SYSTEM AND METHOD FOR SALES GENERATION IN CONJUNCTION WITH A VEHICLE DATA SYSTEM,” and U.S. patent application Ser. No. 15/471,805, filed Mar. 28, 2017, entitled “ VEHICLE DATA SYSTEM FOR RULES BASED DETERMINATION AND REAL-TIME DISTRIBUTION OF ENHANCED VEHICLE DATA IN AN ONLINE NETWORKED ENVIRONMENT”, each of which is hereby incorporated by reference in its entirety for all purposes.

Topology 100 comprises a set of entities including vehicle data system 120 (also referred to herein as the TrueCar system) which is coupled through network 170 to computing devices 110 (e.g. computer systems, personal data assistants, kiosks, dedicated terminals, mobile telephones, smart phones, etc.), and one or more computing devices at inventory companies 140, original equipment manufacturers (OEM) 150, sales data companies 160, financial institutions 182, external information sources 184, departments of motor vehicles (DMV) 180 and one or more associated point of sale locations, for instance, car dealers 130a . . . 130n. Vehicle data system 120 may comprise various resources including hardware and software components supporting a website on network 170. Network 170 may be for example, a wireless or wireline communication network such as the Internet or wide area network (WAN), publicly switched telephone network (PTSN) or any other type of communication link.

Vehicle data system 120 may comprise one or more computer systems with central processing units executing instructions embodied on one or more computer readable media where the instructions are configured to perform at least some of the functionality associated with embodiments of the invention. These applications may include a vehicle data application 190 comprising one or more applications (instructions embodied on a computer readable media) configured to implement an interface module 192, data gathering module 194 and processing module 196 utilized by the vehicle data system 120. Furthermore, vehicle data system 120 may include data store 122 operable to store obtained data 124, data determined during operation 126; models 128, which may comprise a set of dealer cost model or price ratio models, models for determining incentives or other models; or any other type of data associated with embodiments of the invention or determined during the implementation of those embodiments. Data store 122 may include a variety of user data, including user behavioral data, vehicle data, dealer data, manufacturer data and other data.

Vehicle data system 120 may provide a wide degree of functionality including utilizing one or more interfaces provided by interface module 192 configured to for example, receive and respond to queries from users at computing devices 110; interface with inventory companies 140, manufacturers 150, sales data companies 160, financial institutions 182, DMVs 180 or dealers 130a . . . 130n to obtain data; or provide data obtained, or determined, by vehicle data system 120 to any of inventory companies 140, manufacturers 150, sales data companies 160, financial institutions 182, DMVs 180, external data sources 184 or dealers 130a . . . 130n. It will be understood that the particular interface utilized in a given context may depend on the functionality being implemented by vehicle data system 120, the type of network 170 utilized to communicate with any particular entity, the type of data to be obtained or presented, the time interval at which data is obtained from the entities, the types of systems utilized at the various entities, etc. Thus, these interfaces may include, for example web pages, web services, a data entry or database application to which data can be entered or otherwise accessed by an operator, or almost any other type of interface which it is desired to utilize in a particular context.

In general, then, using these interfaces, vehicle data system 120 may obtain data from a variety of sources, including one or more of inventory companies 140, manufacturers 150, sales data companies 160, financial institutions 182, DMVs 180, external data sources 184 or dealers 130a . . . 130n and store such data in data store 122. This data may be then grouped, analyzed or otherwise processed by vehicle data system 120 to determine desired data or models 128 that can be stored in data store 122.

A user at computing device 110 may access the vehicle data system 120 through the provided interfaces and specify certain parameters, such as a desired vehicle configuration or incentive data the user wishes to apply, if any. The vehicle data system 120 can select a particular set of data in the data store 122 based on the user specified parameters, process data using processing module 196, generate interfaces using interface module 192 using the selected data set and data determined from the processing, and present these interfaces to the user at the user's computing device 110.

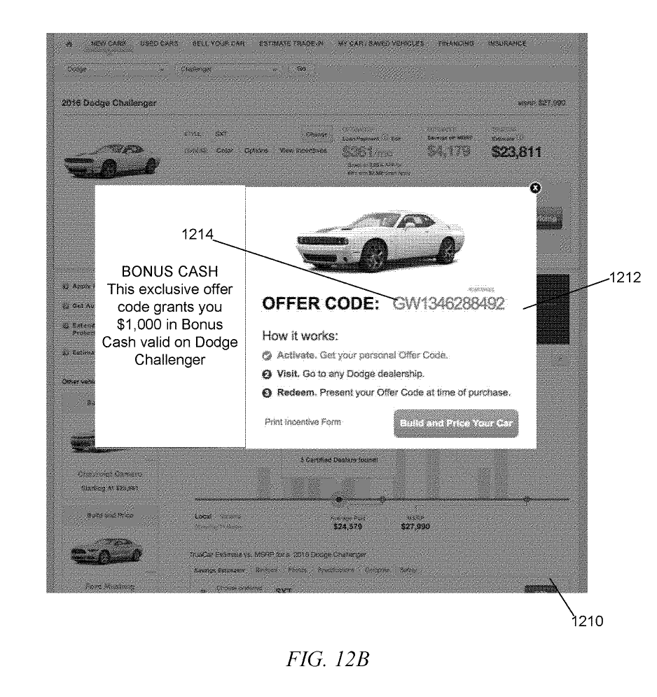

In particular, in one embodiment, users at computer devices 110 may access vehicle data system 120 using one or more web pages of a website that provides a vehicle search service, such as the vehicle search web page illustrated in FIG. 12. As a user browses vehicles, the user may be presented with targeted incentives. A visual interface may present, for example, a downloadable incentive certificate for a first vehicle from a first manufacturer, which may be redeemable at one or more locations. The targeted incentive may be specific to a make, model, trim level, option, or even VIN number. The visual interface may also display targeted incentives from competing manufacturers, for example, to try and persuade the user to choose the competing manufacture over the first manufacture. Furthermore, a visual interface may allow a user to select a targeted incentive to influence pricing data provided by vehicle data system 120. The targeted incentives presented to the user and applied in determining the final price can be targeted to the user based on user behaviors/characteristics as discussed in more detail below.

In one embodiment, a visual interface may present at least a portion of data related to a selected vehicle as a price curve, likelihood curve, bar chart, histogram, etc. that reflects quantifiable prices or price ranges (e.g. “average,” “good,” “great,” “overpriced” etc.) relative to reference pricing data points (e.g., invoice price, MSRP, dealer cost, market average, internet average, etc.). Using these types of visual presentations may enable a user to better understand the pricing data related to a specific vehicle configuration. Additionally, by presenting data corresponding to different vehicle configurations in a substantially identical manner, a user can easily make comparisons between pricing data associated with different vehicle configurations. To further aid the user's understanding of the presented data, the interface may also present data related to incentives which were utilized to determine the presented data or how such incentives were applied to determine presented data.

Turning to the various other entities in topology 100, a dealer (e.g., dealer 130a) may represent a retail outlet for vehicles manufactured by one or more of OEMs 150. To track or otherwise manage sales, finance, parts, service, inventory and back office administration needs, dealers 130a . . . 130n may employ a dealer management system (DMS) 132a . . . 132n. Since many DMSs 132a . . . 132n are Active Server Pages (ASP) based, transaction data (e.g., transaction data 134a . . . 134n) may be obtained directly from a DMS (e.g., transaction data 134a may be obtained directed from DMS 132a for dealer 130a) with a “key” (for example, an ID and Password with set permissions within the DMS 132a) that enables data to be retrieved from the DMS. Many dealers 130a . . . 130n may also have one or more websites which may be accessed over network 170, where pricing data pertinent to respective dealers 130a . . . 130n may be presented on those websites, including incentives for various vehicles carried by respective dealers 130a . . . 130n.

Additionally, a dealer's current inventory may be obtained from a DMS 132 and associated with that dealer's information in data store 122. A dealer 130 may also provide one or more upfront prices to operators of vehicle data system 120. Each of these upfront prices may be associated with a vehicle configuration such that a list of vehicle configurations and associated upfront prices may be associated with a dealer in data store 122. This upfront price may, in one embodiment, comprise an offset from an inventory price for the vehicle configuration. It will be noted that an upfront price may be provided at almost any level of granularity desired. For example, a single upfront price may correspond to all vehicles of a particular make sold by the dealer, to all vehicles of a particular make and model sold by the dealer, to all vehicles of a particular make, model and trim sold by the dealer, etc.

Inventory companies 140 may be one or more inventory polling companies, inventory management companies or listing aggregators which may obtain and store inventory data from one or more of dealers 130a . . . 130n (for example, obtaining such data from DMS 132a). Inventory polling companies are typically commissioned by the dealer to pull data from a DMS 132 and format the data for use on websites and by other systems. Inventory management companies manually upload inventory information (e.g., photos, description, specifications, etc.) on behalf of the dealer. Listing aggregators get their data by “scraping” or “spidering” websites that display inventory content and receiving direct feeds from listing websites (for example, Autotrader, FordVehicles.com).

DMVs 180 may collectively include any type of government entity to which a user provides data related to a vehicle. For example, when a user purchases a vehicle it must be registered with the state (for example, DMV, Secretary of State, etc.) for tax and titling purposes. This data typically includes vehicle attributes (for example, make, model, mileage, etc.) and sales transaction prices for tax purposes.

Financial institution 182 may be any entity such as a bank, savings and loan, credit union, etc. that provides any type of financial services to a participant involved in the purchase of a vehicle. For example, when a buyer purchases a vehicle they may utilize a loan from a financial institution, where the loan process usually requires two steps: applying for the loan and contracting the loan. These two steps may utilize vehicle and consumer information in order for the financial institution to properly assess and understand the risk profile of the loan. Typically, both the loan application and loan agreement include proposed and actual sales prices of the vehicle.

Sales data companies 160 may include any entities that collect any type of vehicle sales data. For example, syndicated sales data companies aggregate new and used sales transaction data from the DMSs 132a . . . 132n of particular dealers 130a . . . 130n. These companies may have formal agreements with dealers 130a . . . 130n that enable them to retrieve data from a dealer 130 in order to syndicate the collected data for the purposes of internal analysis or external purchase of the data by other data companies, dealers, and OEMs.

Manufacturers 150 are those entities which actually build the vehicles sold by dealers 130a . . . 130n. In order to guide the pricing of their vehicles, the manufacturers 150 may provide an Invoice price and a Manufacturer's Suggested Retail Price (MSRP) for both vehicles and options for those vehicles—to be used as general guidelines for the dealer's cost and price. These fixed prices are set by the manufacturer and may vary slightly by geographic region. Manufacturer systems may also provide incentives.

External information sources 184 may comprise any number of other various source, online or otherwise, which may provide other types of desired data, for example data regarding vehicles, pricing, demographics, economic conditions, markets, locale(s), consumers, etc.

It should be noted here that not all of the various entities depicted in topology 100 are necessary, or even desired, in embodiments of the invention, and that certain of the functionality described with respect to the entities depicted in topology 100 may be combined into a single entity or eliminated altogether. Additionally, in some embodiments, other data sources not shown in topology 100 may be utilized. Topology 100 is therefore exemplary only and should in no way be taken as imposing any limitations on embodiments of the invention.

At certain intervals, vehicle data system 120 may obtain by gathering (for example, using an interface of interface module 192 to receive or request) data from one or more of inventory companies 140, manufacturers 150, sales data companies 160, financial institutions 182, DMVs 180, external data sources 184 or dealers 130. This data may include sales or other historical transaction data for a variety of vehicle configurations, inventory data, registration data, finance data, vehicle data, incentive data and other data. It should be noted that differing types of data may be obtained at different time intervals, where the time interval utilized in any particular embodiment for a certain type of data may be based, at least in part, on how often that data is updated at the source, how often new data of that type is generated, an agreement between the source of the data and the providers of the vehicle data system 120 or a wide variety of other factors. Once such data is obtained and stored in data store 122, it may be analyzed and otherwise processed to yield data sets corresponding to particular vehicle configurations (which may include, for example, include vehicle make, model, power train, options, etc.) and geographical areas (national, regional, local, city, state, zip code, county, designated market area (DMA), or any other desired geographical area).

At some point then, a user at a computing device 110 may access vehicle data system 120 using one or more interfaces, such as a set of web pages provided by vehicle data system 120. Using this interface, a user may browse vehicles by querying vehicle data system based on a certain set of vehicle attributes (make, model, trim, power train, options, etc.) or other relevant information such as a geographical location. The user may also specify a purchase date, or window of purchase dates of interest. In some cases, a user may prospect a vehicle. That is, the user may request a dealer price quote, such as upfront pricing, on a particular vehicle configuration. Prospecting may require the user to register for an account with vehicle data system 120 or provide additional personal information.

A consumer's propensity to buy any particular vehicle may be a function of many variables, including but not limited to: affordability, brand affinity/loyalty, product attributes, selection (available inventory), and perceived value. Vehicle data system 120 can be configured to provide incentives targeted to the user based on any number of factors including, but not limited to user demographics [e.g., age, income, gender], previous buying behavior, cross-shop behavior, location, intent, response rates, affiliation with trusted non-automotive brands, level of interest in different vehicle models. In some embodiments, the targeted incentive may be specifically tuned to a user segment to which the user belongs.

As a user interacts with vehicle data system 120 via the interface, vehicle data system 120 may collect a set of observable features associated with the user. The observable features may be collected in the context of a single search session or across sessions and may include information input by the particular user and information, such as user activities/interactions/preferences and vehicle configuration, collected by vehicle data system 120 (e.g., via a website). More specifically, according to one embodiment, vehicle data system 120 can collect information input by the user and a usage log containing activities associated with the user, such as the sequence of search queries made, items viewed or prospected and the order in which they were viewed/prospected and other activities of the user. Vehicle data system may also collect information such as whether the user is accessing vehicle data system 120 through a website of a trusted affiliate. The observable features of the user may be used to locate one or more components previously determined and stored by the vehicle data system 120 and associated with one or more of the observable features provided by the user. These components may include, for example, incentives targeted to specific user segments.

In one embodiment, incentives may be associated with vehicle categories and user segments that represent users exhibiting particular behaviors or characteristics. In response to a query from the user, processing module 196 can match the query to a vehicle category. In addition, processing module can apply segment matching rules to the observable features of the user to match the observable features of user with one or more defined segments. The segment matching rules, according to one embodiment, may match a user to a segment based determining if one or more observable features of the user meet criteria specified for a segment. In some cases, the matching rules may generate similarity scores with respect to define segments and match the user to the segment based on the similarity scores (i.e., match the user to the segment to which he or she is most similar). An incentive associated with the determined segment and vehicle category can be presented to the user in a visual display in real-time. For example, the incentive determined for the user may be included in a web page generated in response to the query. Because incentives are targeted to users based on user segments, different users requesting the same web page or vehicle information may be presented different incentives based on their behavior or other characteristics.

Incentive levels and segments associated with vehicles may be defined by a data operator with sufficient privileges (e.g., an administrator), provided by OEMs or other data sources or be otherwise defined. In other embodiments, vehicle data system 120 may include segmenting rules for grouping users based on similarities (rules for defining segments). Furthermore, vehicle data system 120 may include one or more models 128, such as a set of vehicle specific demand models that are utilized to optimize incentives for vehicles and/or vehicle, segment combinations. These and other aspects of various embodiments are discussed further below.

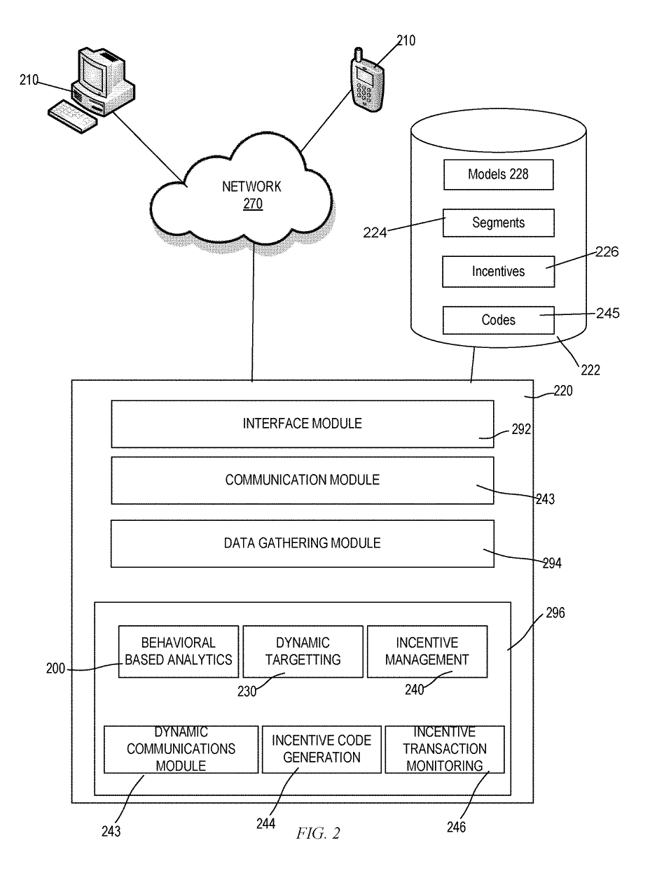

Turning now to FIG. 2, one embodiment of a vehicle data system 220, which may implement an embodiment of vehicle data system 120 described above, is illustrated. Vehicle data system 220 may comprise interface module 292, data gathering module 294, and processing module 296. Interface module 292 may provide a mechanism for user devices 210 to interact with system 220 over network 270 in a manner similar to interface module 192 described above. Network 270 may be the same or similar to network 170 described above. Similar to data gathering module 194 described above, data gathering module 294 may obtain or receive data from one or more sources (e.g., OEM, inventory companies, dealers, financial institutions, DMVs, data providers, etc.).

Furthermore, vehicle data system 220 may include data store 222 operable to store obtained data, data determined during operation and other data. User segments 224 corresponding to users having similar observable features may be persisted in data store 222. In some embodiments, a user segment 224 may define a group of consumers based on behaviors or characteristics (e.g., search behavior, price, drive distance, vehicle colors, geographic resolution such as zip code, and/or user-specific data such as household income, social-economic status, etc.). Identifying or determining a user segment may be done using observable features representing and/or relating to these characteristics. Values for observable features may be obtained via a website supported by system 220, for instance, using user input provided via the website and/or information relating to aforementioned behaviors or characteristics collected by the website.

Incentives 226, which may be associated with manufacturers, dealers or other entities and assigned monetary values or other benefits, are persisted in data store 222. These incentives 226 may be allocated to users in a targeted manner based on segments 224. To facilitate this targeted distribution of incentives, various incentives can be assigned to vehicle categories to provide different incentive levels for the categories, where a vehicle category represents a particular make, vehicle segment (e.g., sedan, SUV), model, and/or trim level, depending upon implementation. An incentive level, according to one embodiment, can be associated with a segment 224. For example, for a vehicle category Manufacturer X/Model X1, a first incentive level may include a first incentive 226 that is associated with a first segment 224 and a second incentive level may include a second incentive 226 associated with a second segment 224. In some embodiments, incentives 226 may be specifically tuned to the vehicle categories on a per user segment basis. In one particular example, incentives may be specifically tuned for vehicle make/models and user segments such that, for example, users in different segments may receive different incentives on the same make/model, while users in the same segment may receive different incentives on a different make/model by the same manufacturer.

Data store 222 may further include models 228 that can be used in determining incentives and incentive levels. In some embodiments, processing module 296 may use the data obtained or received by data gathering module 294 to build models 228 and determine levels of incentives 226 for vehicles categories, which may then be persisted in data store 222. For example, a machine learning dynamic incentive targeting module 230 may be configured to develop various models 228 from historical data and determine potential user segments.

Processing module 296 of system 220 may comprise behavioral based analytics 200. Behavioral based analytics 200 may implement rules to determine incentive levels and/or allocation of incentives for one or more user segments. In some embodiments, system 220 may receive a query, via a website supported by system 220, from user device 210 over network 270. By applying segment matching rules to match a user to a segment 224 based on observable features of the user and utilizing incentive levels persisted in data store 222, behavioral based analytics 200 may be used to determine an incentive 226 specific for a user at user device 210. Observable features may include information input by the particular user and information, such as user behavior and vehicle configuration, collected by a website.

Vehicle data system 220 may further include an incentive management module 240 that records metadata about incentives being offered. Incentive management module 240 may validate metadata and/or business rules for distribution of incentives. According to one embodiment, incentive management module 240 allows OEM data operators to record metadata about incentives.

In the embodiment of FIG. 2, system 220 further comprises a consumer communication module 243 to provide communication with users via email, short message system (SMS), or by phone call, including automated phone calls. The consumer communication module 243 can be configured to generate messages based on dynamic incentive information and send messages at optimal times learned by the machine learning dynamic incentive targeting module 230. Thus, users can be updated as incentives change or new incentives become available.

Incentive code generation system 244 is configured to generate unique redemption codes 245 associated with incentives that can be provided to users in the form of a numerical code, bar code, QR code or other code. Incentive code generation system 244 can associate the redemption code with user in system 220. Incentive redemption and transaction matching system 246 is configured to match a redemption code received from, for example, a dealer system, with a redemption code 245 in data store 222 to confirm that an incentive should be provided to a user participating in a transaction (e.g., at the dealer).

Interface module 292 may provide application programming interfaces (API) through which applications can retrieve dynamic incentive information. The API may also be used to retrieve and return learned user segments. Interface module 292 may also provide an interface to a customer portal (e.g., a website) through which vehicle data system 220 may present an interface to a user at the user's computer device 210 over the computer network 270. Through the customer portal, a user can register for an account, provide personal information and provide relevant information such as attributes of a desired vehicle configuration, a geographic area, or other parameters through the interface.

In accordance with one embodiment, system 220 may receive a query via the customer portal (e.g., a website supported by system 220), from user device 210 over network 270. Behavioral based analytics 200 can apply a set of segment matching rules to the observable features (e.g., user characteristics, user behavior, vehicle configuration, geography, etc.) to map the user to a segment. Based at least in part on the segment, behavioral based analytics 200 can identify incentives targeted to the user.

Based on determining an incentive to present to a user or the user selection of an incentive 226, incentive code generation system 246 may generate an incentive certificate with a unique redemption code 245 that can be provided to the user via the website. The redemption code 245 may be associated with the selected incentive 226 and user in data store 222. The incentive and code can be passed to the interface module 292 so that the customer portal can provide, in real-time, a responsive interface (e.g., web page) including incentives targeted at that user. The incentive may be presented as a user selectable incentive that, if selected, vehicle data system 220 will use in determining pricing information to display to the user via the website.

Interface module 292 may also provide an interface to a dealer portal through which a dealer data operator at a dealer system 132 can input and receive data. For example, the dealer portal may allow the dealer to submit redemption codes and user data and receive a verification.

Furthermore, interface module 292 may provide an interface to an OEM portal through which an OEM data operator at an OEM system may interact with vehicle data system 220 over network 270. The OEM data operator may select incentives to define incentive levels, associate segments to incentive levels, provide incentive amounts, specify rules for applying incentives and take other actions. As discussed below, vehicle data system 220 may recommend incentives, segments and/or incentive levels to the OEM or other entity for selection.

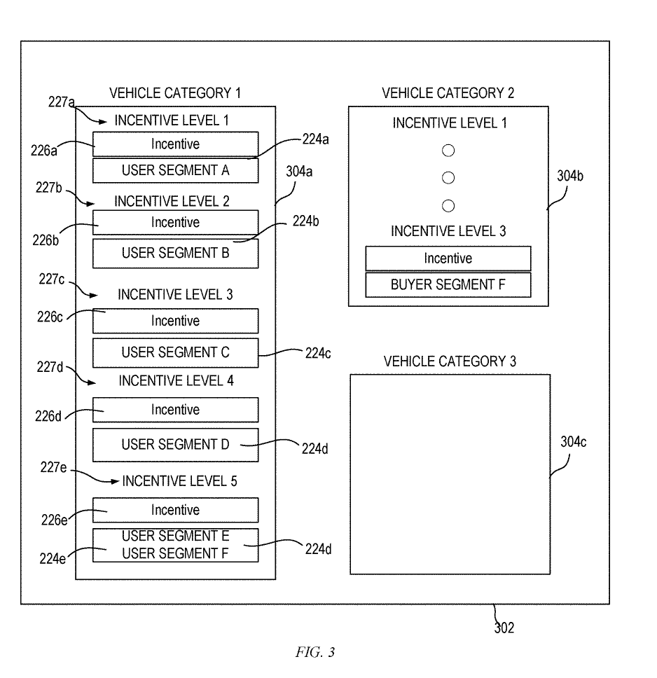

Turning briefly to FIG. 3, FIG. 3 is a diagrammatic representation of one example of a targeted incentive database data set 302 (e.g., as one or more data tables) which may be persisted in an embodiment of data store 222 described above. Data 302 may contain a number of vehicle categories 304 (individually illustrated as categories 304a . . . 304c). Each vehicle category 304 may be associated with a particular make, type (e.g., sedan, SUV), model, and/or trim level, depending upon implementation. One or more vehicle category incentive levels 227 (individually 227a, 227b . . . ) include incentives 226 (individually, incentives 226a, 226b . . . ). Each incentive level for a vehicle category 304 may also be associated with one or more user segments 224 (individually illustrated as buyer segments 224a, 224b . . . ). The example of FIG. 3 is only one example of data which may be used. Skilled artisans will appreciate that incentive levels may be persisted in a number of ways and formats so as to allow the system to determine an incentive level for a specific vehicle category and user segment.

Vehicle category incentive levels 227 are mapped to segments 224 that correspond to user behaviors or characteristics such as, but are not limited to, browsing a specific incentivized vehicle model, browsing a competitive model, prospecting on an incentivized model, prospecting on a competitive model, failure to indicate a purchase after N days, defined clusters (e.g., age, gender, household income, cross-shop, etc.) Incentive levels can be particularly mapped to vehicle models by using mapping codes which match vehicle models with incentive levels. On an ongoing basis, the mappings can be updated as new vehicle models show up and discontinued models drop off.

To provide an example, vehicle category 304a may represent Manufacturer X/Model X1 and vehicle category 304b may represent Manufacturer Y/Model Y1. Furthermore, Models X1 and Y1 may be members of a competitive set of vehicles. In the example illustrated, five incentive levels are defined for vehicle category 304a. Incentive level 227a (“Incentive Level 1”) includes an incentive 226a of $750 that is associated with segment 224a (“User Segment A”) corresponding to users who submit searches for Manufacturer X/Model X1 (i.e., specify the specific make and model as their point of entry to the manufacturer's products). Incentive level 227b (“Incentive Level 2”) includes an incentive 226b of $250 associated with a segment 224b (“User Segment B”) corresponding to users who search Manufacturer X. While users in User Segment B may eventually select to view information from Model X1, they may be considered to belong to different segment than User Segment A because the users in User Segment B reached Model X1 by a different path.

Incentive level 227c (“Incentive Level 3”) includes incentive 226c of $1000 associated with segment 224c (“User Segment C”) corresponding to users who view a competitive model (e.g., Model Y1). Incentive level 227d (“Incentive Level 4”) includes incentive 226d of $2000 associated with segment 224d (“Buyer Segment D”) corresponding to users who download a competitor's incentive certificate. Incentive level 227e includes an incentive 226e of $500 associated with users who prospected Model X1, but did not complete a purchase of Model X1 in 5 days (segment 227e) and then 10 days (segment 227f).

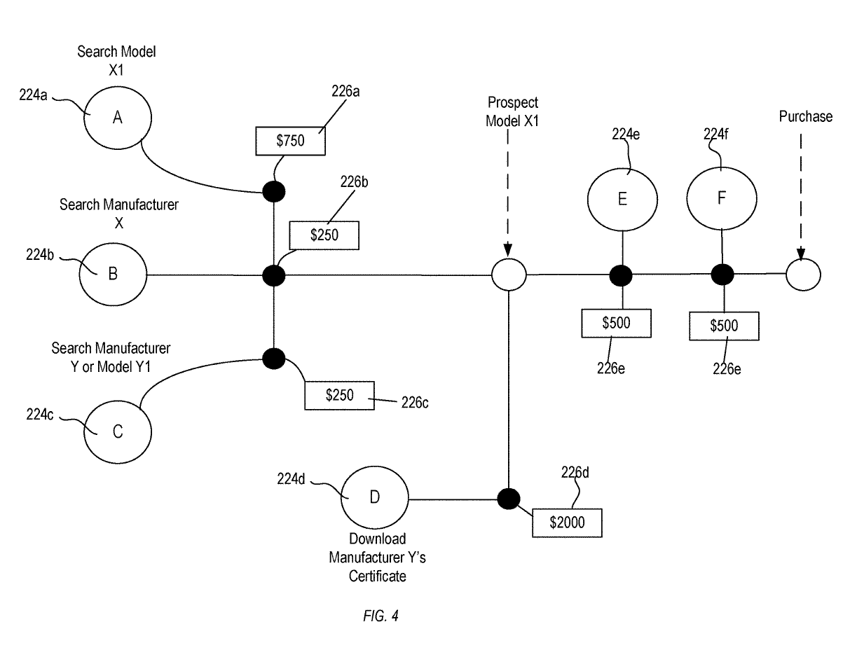

The incentive levels associated with vehicle category 304a are further depicted in FIG. 4, which provides a diagrammatic representation illustrating one example of various incentives a user may receive at various points based on his or her behavior. For example, the segment matching rules may place a user searching for a specific make and model of a vehicle in User Segment A. This user may be offered one level of incentive 226a for the specific vehicle searched because, for example, it may be assumed that the user already has decided which model to purchase or is strongly interested in that model. The segment matching rules may place a user searching by only manufacturer in User Segment B. This may be offered a different incentive 226b because, for example, the user may be undecided on which model to purchase. The segment matching rules may match a user searching for a competitive make/model in a User Segment C. Yet a third level of incentive (incentive 226c) may be given to that user.

Additionally, in some embodiments, a user who downloaded an incentive certificate for a first vehicle from a first manufacturer, which may be redeemable at one or more locations. The incentive may be specific to a make, model, trim level, option, or even VIN number. The segment matching rules may match a user who downloads a competitor's incentive certificate in User Segment D. Such a user may be offered a fourth incentive 226d from the first manufacturer.

Additional incentive offers may be sent to a user based on other events. For example, a user may be offered an additional incentive by the first manufacture (e.g., incentives 226e, 226f) at specified times after the user downloaded the first manufacturer's certificate. In this example, the behavior analytics segment matching rules may be applied to user data to determine if, for example, the user has prospected a vehicle, but not yet purchased the vehicle within a certain time. As can be understood then, behavioral analytics segment matching rules may thus be applied to data about a user not only when the user is online with the vehicle data system, but also when the user is offline.

Some of these targeted incentives, such as incentives 226a, 226b, 226c and 226d, may be provided in real-time as a user uses a website or other interface to browse vehicles. For example, a targeted incentive may be provided in a web page generated in response to a query. Other incentives, such as incentives 226e, 226f, may be sent by communication module 243 via another channel (e.g., SMS, email) to the user at the appropriate times.

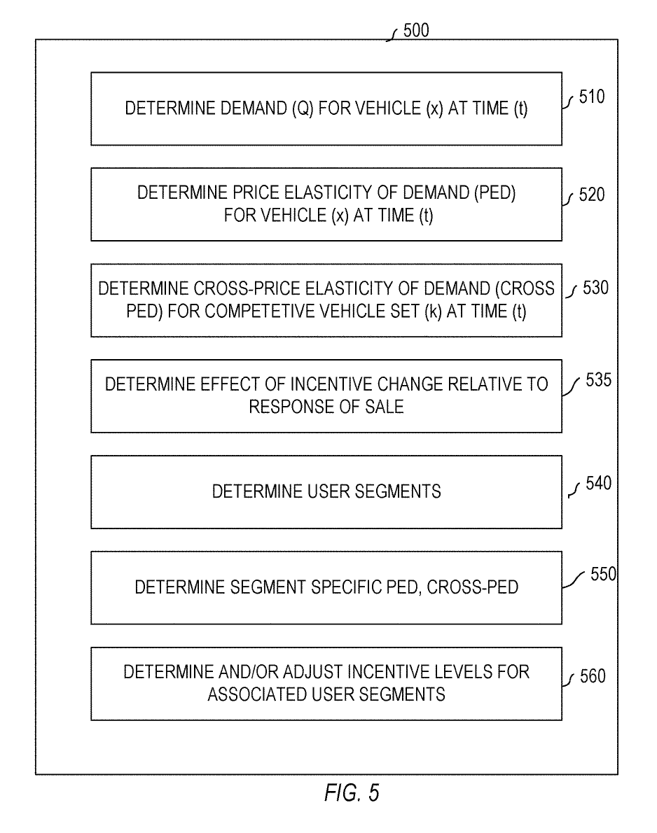

As discussed above, a vehicle data system may provide targeted incentives to users based on user segments. Moreover, a vehicle data system may optimize targeted incentives for a particular vehicle category including, in some embodiments, on a per user segment basis. Optimizing targeted incentives may include a number of operations. Example operations performed by a system are illustrated in FIG. 5. More particularly, FIG. 5 illustrates a system 500, which may be a vehicle data system 120, 220, establishing the demand model Q for a vehicle x and its competitive set of vehicles xk (operation 510), determining the price elasticity of demand (PED) and cross-elasticity of demand (cross-PED) for vehicle x and its competitive set of vehicles xk (operations 520, 530), determining the effect of incentive changes relative to response of sale (operation 535), determining user segments (operation 540), determining PED, cross-PED and demand responses on a segment specific basis (operation 550), and tuning incentive levels for user segments (operation 560). Skilled artisans will appreciate that system 500 is not limited to the example operations shown and described with reference to FIG. 5 and may perform any combination of the operations shown in FIG. 5 in addition to operations not listed here.

With further reference to FIG. 5, system 500 may determine the demand Q of vehicle x and in time t using data collected from one or more sources (operation 510). More particularly, system 500 may use a demand model to determine the demand of vehicle x in time t. Time t may be at any selected time period (e.g., day, month, quarter, years or multiple days, months, quarters or years). Vehicle may x refer to a specific vehicle configuration and may be defined at any level, including a particular year, make, model, and/or trim level, depending upon implementation. For the purposes of further discussion, the example of make/model level will be used. Thus the demand Q_{x,t} may represent the demand Q of vehicle x at the make/model level at time t and may be expressed in various ways such as in units or market share of a make/model of a particular segment or overall industry sales units. A vehicle category with which targeted incentives are associated (e.g., vehicle category 304 FIG. 3) may correspond to and be defined at the same level as vehicle x (e.g., make/model).

As discussed further below, the demand model Q_{x,t} may incorporate data related to a competitive set of vehicles xk. Vehicles xk represents or refers to vehicles in a competitive vehicle set at the same level as vehicle x (e.g., make/model), where k is an integer. If, for example, there five other make/models in the competitive vehicle set with vehicle x, then k=1 . . . 5 and x1 represents on competitive make/model, x2 represents another competitive make model and so on. According to one embodiment, system 500 may determine a competitive vehicle set based on the set of vehicles (e.g., at the make/model level of vehicle x) that have the highest conditional probability of being purchased relative to vehicle x as a baseline item. The competitive set may be determined based on similarities between models and aggregate search behavior of users searching vehicles via a vehicle data system. U.S. Pat. No. 9,508,084, issued Nov. 29, 2016, entitled “SYSTEM, METHOD AND COMPUTER PROGRAM PRODUCT FOR PREDICTING ITEM PREFERENCE USING REVENUE-WEIGHTED COLLABORATIVE FILTER,” which is hereby incorporated in its entirety by reference herein for all purposes, describes one embodiment of determining conditional probabilities of item selection and determining competitive sets of items based on similarity and aggregate search behavior. In another embodiment, a competitive vehicle set may comprise a set of make/models that are defined as competitive in the industry (e.g., various makes/models of mid-size sedans may be considered competitive).

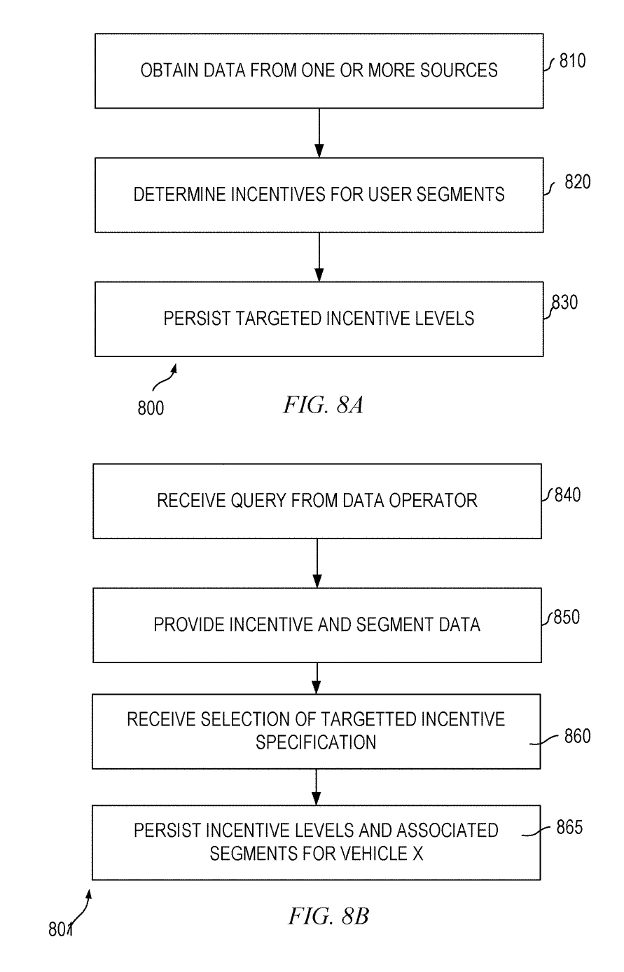

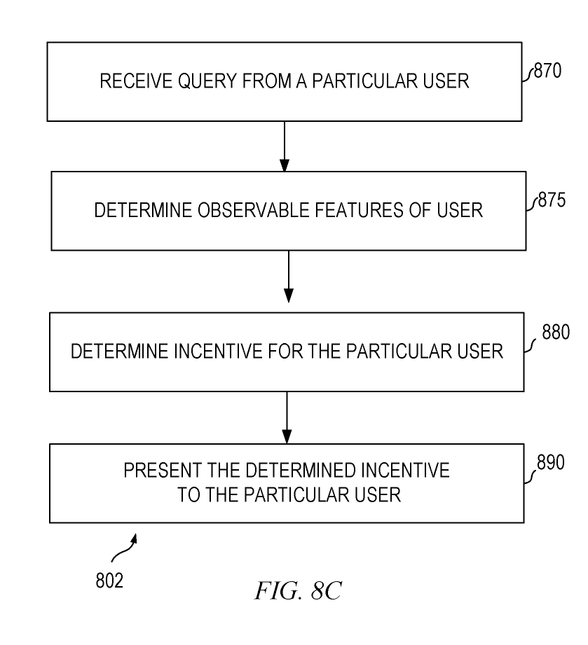

The demand model may be trained using historical data collected from one or more sources. Data collection may be performed on an ongoing basis, independently of operation 510. Further, operation 510 may be performed independently of a user request received via a website supported by system 500 from a user device over a network or from an OEM portal. Put another way, operation 510 may be a back-end operation. For instance, operation 510 may be performed in an offline process, as described below with reference to FIG. 8.

As a non-limiting example, the demand for a vehicle x in time t (Q_{x,t}) may be determined according to the demand model:

$$f ( x ) = {Q}_{x , t} = a + {β}_{1} {P}_{x , t} + {\sum }_{k = 1}^{K} {β}_{2} {P}_{xk , t} + {\sum }_{m = 1}^{M} {β}_{3} {E}_{t} + {\sum }_{v = 1}^{V} {β}_{4} {V}_{xt} + {\sum }_{vk = 1}^{Vk} {β}_{5} {V}_{xk , t} + {\sum }_{i}^{N} {\sum }_{p = 1}^{m} {β}_{6} {B}_{i , p , x , t} + {β}_{7} {A}_{x , t} + {β}_{8} {S}_{x , t} + {\sum }_{ℊ = 1}^{G} {β}_{9} {G}_{x , t} + e$$

where a represents the intercept of the demand function, βₙ are the coefficients of the model variables and e represents an error term, as those skilled in the art can appreciate.

P_{x,t} represents the price of vehicle x in time t (vehicle transaction price net of incentives). More particularly, P_{x,t} may be defined as the MSRP minus the weighted incentives:

$${P}_{x , t} = {MSRP}_{x , t} - {\sum }_{i = 1}^{I} {w I}_{x , t}$$

where MSRP_{x,t} refers to the Manufacturers Suggested Retail Price (MSRP) of vehicle x in time t. In a given time period t, a manufacturer may have offered several trim levels of a model at different MSRPs. If the demand model is built at the model level, the MSRP_{x,t} may be a trim weighted MSRP at the model level where the various trim MSRPs are weighted to produce MSRP_{x,t}. The MSRP for a trim may be weighted based on that trim's portion of the total units of model x,t sold in t, portion of advertising dedicated to that trim, predetermined weights selected by the manufacturer or other weighting scheme. Σᵢ₌₁^{I}wl_{x,t} refers to the vehicle incentive amount weighted by incentive type (weight w) of incentives for vehicle x in time t (e.g., at the model level). Example incentive types may include customer cash, dealer cash, lease cash, APR cash, APR support, lease subvention, etc. According to one embodiment, the weight can reflect the take rate of the type of incentive for the vehicle. In addition, trim specific incentives may be trim weighted. Σₖ₌₁^{K}P_{xk,t} represents the vehicle prices P (vehicle transaction price net of incentives) of vehicles xk=1, 2, . . . , XK in competitive vehicle set at the make/model level in time t. P_{xk,t} may be defined as:

$${P}_{xk , t} = {MSRP}_{xk , t} - {\sum }_{i = 1}^{I} {wI}_{xk , t}$$

where MSRP_{xk,t} refers to the MSRP of vehicles in the competitive set in time t. MSRP_{xk,t} may be a trim weighted MSRP for the model xk in time t if various trims of vehicle xk had different MSRPs in time t. Σᵢ₌₁^{I}wI_{xk,t} refers to the vehicle incentive amount weighted by type (weight w) of incentives for vehicles in the competitive set in time t. The incentives may also be trim weighted.

In this example, Σ^{m=1}^{M}Eₜ represents macro-economic conditions E in time t (e.g., unemployment rate, GDP growth, consumer confidence, real per capita disposable income). Σᵥ₌₁^{V}Vₓₜ represents vehicle specific attributes v=1, 2, . . . , V of vehicle x in time t (e.g., miles per gallon, horsepower, content (e.g., navigation, leather, etc.), lifecycle information (e.g., new generation, mid-cycle refresh, number of years till new generation)). Σᵥₖ₌₁^{Vk}V_{xk,t} represents vehicle specific attributes vk=1, 2, . . . , Vk of vehicles xk in time t. Σᵢ^{N} Σₚ₌₁^{m} B_{i,p,x,t} represents buyers i=1, 2, . . . , N having profile features p=1, 2, . . . , m (e.g., age, gender, household income, cross-shop preferences (e.g., loyalty/conquest, etc.)) who purchased vehicle x in time t.

Furthermore, A_{x,t} represents media advertising in dollars spent on vehicle x in time t. S,_{x,t} represents the price seasonality of vehicle x in time t, that is the influence of season on price. For example, from historical data, trends in price based on seasonality and model year cycle can be seen, as well as large single-day changes, which may often be related to holidays. Therefore, each model may have a seasonality factor for each season (month or other defined time period) that represents the effect of season on transaction prices. Σ_{g=1}^{G} G_{x,t} represents an accounting for the spatial component of vehicle x in time t, where G_{x,t} is a binary variable (e.g., if the vehicle is in spatial area G1, then G1=1, otherwise G1=0) and spatial areas can be defined as a full zip code, a 3-digit zip code, a Designated Market Area (DMA), states, regions, etc.

Using historical data the actual past demand for vehicle x at multiple prices and the various other pieces of data are known. As such a, the Betas , e and incentive weights w can be determined using multivariate regression analysis or other machine learning techniques. A set of demand models may thus be generated at step 510 for various models x and stored in the data store of a vehicle data system. Furthermore, demand models for a vehicle x can be built for multiple spatial areas. In any event, the demand models provide rules for generating price elasticity of demands (PED), cross price elasticity of demands (cross-PED) and demand responses for a vehicle x. Any numerical optimization method, whether now known or hereafter derived in the art, may be alternatively, conjunctively or sequentially employed to achieve a substantially similar result. The models may be retrained continuously or periodically. Furthermore, older data may be weighted less than more recent data.

Using a demand model for vehicle x, system 500 can accurately predict the effect of incentives on sales and select or recommend optimized incentive levels for a vehicle x. More particularly, system 500 uses the selected demand model to determine the price elasticity of demand (PED) for vehicle x at time t (operation 520). The PED of vehicle x in time t (ε_{px,t}) shows the change in demand Q of vehicle x in time t from a price change of vehicle x in time t and may be defined as:

$${ɛ}_{px , t} = \frac{\frac{{dQ}_{x , t}}{{Q}_{x , t}}}{\frac{{dP}_{x , t}}{{P}_{x , t}}} = \frac{\frac{\begin{matrix}d ( a + {β}_{1} {P}_{x , t} + {\sum }_{k = 1}^{K} {β}_{2} {P}_{xk , t} + {\sum }_{m = 1}^{M} {β}_{3} {E}_{t} + {\sum }_{v = 1}^{V} {β}_{4} {V}_{xt} + {\sum }_{vk = 1}^{Vk} {β}_{5} {V}_{xk , t} + \\ {\sum }_{i}^{N} {\sum }_{p = 1}^{m} {β}_{6} {B}_{i , p , x , t} + {β}_{7} {A}_{x , t} + {β}_{8} {S}_{x , t} + {\sum }_{ℊ = 1}^{G} {β}_{9} {G}_{x , t} + e )\end{matrix}}{\begin{matrix}( a + {β}_{1} {P}_{x , t} + {\sum }_{k = 1}^{K} {β}_{2} {P}_{xk , t} + {\sum }_{m = 1}^{M} {β}_{3} {E}_{t} + {\sum }_{v = 1}^{V} {β}_{4} {V}_{xt} + \\ {\sum }_{vk = 1}^{Vk} {β}_{5} {V}_{xk , t} + {\sum }_{i}^{N} {\sum }_{p = 1}^{m} {β}_{6} {B}_{i , p , x , t} + {β}_{7} {A}_{x , t} + {β}_{8} {S}_{x , t} + {\sum }_{ℊ = 1}^{G} {β}_{9} {G}_{x , t} + e )\end{matrix}}}{\frac{d ( {MSRP}_{x , t} - {\sum }_{i = 1}^{I} {wI}_{x , t} )}{( {MSRP}_{x , t} - {\sum }_{i = 1}^{I} {wI}_{x , t} )}}$$

The PED may be determined by selecting a change in P_{x,t} of a selected amount, say 1%, to determine the change in demand based on the demand model.

System 500 may also determine the cross-price elasticity of demand (cross-PED) for a competitive vehicle set k at time t (operation 530). The cross-PED of vehicle x in time t compared to change of vehicle price of vehicles of competitive set xk may be defined as:

$${ɛ}_{pxk , t} = \frac{\frac{{dQ}_{x , t}}{{Q}_{x , t}}}{\frac{d ( {P}_{xk , t} )}{( {P}_{xk , t} )}} = \frac{\frac{\begin{matrix}d ( a + {β}_{1} {P}_{x , t} + {\sum }_{k = 1}^{K} {β}_{2} {P}_{xk , t} + {\sum }_{m = 1}^{M} {β}_{3} {E}_{t} + {\sum }_{v = 1}^{V} {β}_{4} {V}_{xt} + {\sum }_{vk = 1}^{Vk} {β}_{5} {V}_{xk , t} + \\ {\sum }_{i}^{N} {\sum }_{p = 1}^{m} {β}_{6} {B}_{i , p , x , t} + {β}_{7} {A}_{x , t} + {β}_{8} {S}_{x , t} + {\sum }_{ℊ = 1}^{G} {β}_{9} {G}_{x , t} + e )\end{matrix}}{\begin{matrix}( a + {β}_{1} {P}_{x , t} + {\sum }_{k = 1}^{K} {β}_{2} {P}_{xk , t} + {\sum }_{m = 1}^{M} {β}_{3} {E}_{t} + {\sum }_{v = 1}^{V} {β}_{4} {V}_{xt} + \\ {\sum }_{vk = 1}^{Vk} {β}_{5} {V}_{xk , t} + {\sum }_{p = 1}^{m} {β}_{6} {B}_{i , p , x , t} + {β}_{7} {A}_{x , t} + {β}_{8} {S}_{x , t} + {\sum }_{ℊ = 1}^{G} {β}_{9} {G}_{x , t} + e )\end{matrix}}}{\frac{d ( {MSRP}_{xk , t} - {\sum }_{i = 1}^{I} {wI}_{xk , t} )}{( {MSRP}_{xk , t} - {\sum }_{i = 1}^{I} {wI}_{xk , t} )}}$$

The foregoing assumes that cross-PED is being evaluated against a single competitive model at a time, however, if cross-PED is evaluated against multiple models then:

$${ɛ}_{pxk , t} = \frac{\frac{{dQ}_{x , t}}{{Q}_{x , t}}}{\frac{d ( {\sum }_{k = 1}^{K} {P}_{xk , t} )}{( {\sum }_{k = 1}^{K} {P}_{xk , t} )}}$$

wheren xk are the models against which cross-PED is being evaluated.

The cross-PED shows the change in demand Q of vehicle x in time t from a price change in vehicles of the competitive set xk=1,2, . . . , XK. The cross-PED may be determined by selecting a change in P_{xk,t} for a particular k and amount, say 1%, to determine the corresponding change in demand based on the demand model.

System 500 may determine the effect of incentive changes relative to response of sale (operation 535). More particularly, the change in demand (change in %) based on change in vehicle price Pₓ of vehicle x in time t due solely to incentives may be defined as:

$$\frac{{dQ}_{x , t}}{{Q}_{x , t}} = \frac{{dP}_{x , t}}{{P}_{x , t}} {ɛ}_{px , t} = \frac{d ( {\sum }_{i = 1}^{I} {wI}_{x , t} )}{( {MSRP}_{x , t} - {\sum }_{i = 1}^{I} {wI}_{x , t} )} {ɛ}_{px , t}$$

Again, this may be extended to multiple vehicles in competitive set:

The change in units (or market share) demanded based on change in vehicle price Pₓ (solely incentive) of vehicle x in time t may be defined as:

$$= {Q}_{x , t} ( \frac{{dP}_{x , t}}{{P}_{x , t}} {ɛ}_{px , t} ) = {Q}_{x , t} ( \frac{d ( {\sum }_{i = 1}^{I} {wI}_{x , t} )}{( {MSRP}_{x , t} - {\sum }_{i = 1}^{I} {wI}_{x , t} )} {ɛ}_{px , t} )$$

The response in demand (change in %) based on change in vehicle price Pₓₖ (solely incentive) of vehicles of competitive set xk in time t may be defined as:

$$\frac{{dQ}_{x , t}}{{Q}_{x , t}} = \frac{{dP}_{xk , t}}{{P}_{xk , t}} {ɛ}_{pxk , t} = \frac{d ( {\sum }_{i = 1}^{I} {wI}_{xk , t} )}{( {MSRP}_{xk , t} - {\sum }_{i = 1}^{I} {wI}_{xk , t} )} {ɛ}_{px , t}$$

In the above equation, the MSRP may be held constant to streamline the calculation. The change in units demanded based on change in vehicle price Pₓₖ of vehicles of competitive set xk in time t based solely on incentives may be defined as:

$$= {Q}_{x , t} ( \frac{{dP}_{xk , t}}{{P}_{xk , t}} {ɛ}_{pxk , t} ) = {Q}_{x , t} ( \frac{d ( {\sum }_{i = 1}^{I} {wI}_{xk , t} )}{( {MSRP}_{xk , t} - {\sum }_{i = 1}^{I} {wI}_{xk , t} )} {ɛ}_{pxk , t} )$$

According to one embodiment, system 500 may, for each vehicle x in a set of vehicles, periodically use a current demand model for that vehicle x to determine a PED and cross-PEDs for that vehicle x, which may be persisted in a vehicle data system data store. If demand models are established for multiple spatial areas, system 500 may determine PEDs and cross-PEDs for vehicle x for each spatial area. Thus, for example, a vehicle data system may store PEDs and cross-PEDs for each make/model of vehicle for which manufacturers or dealers may offer incentives.

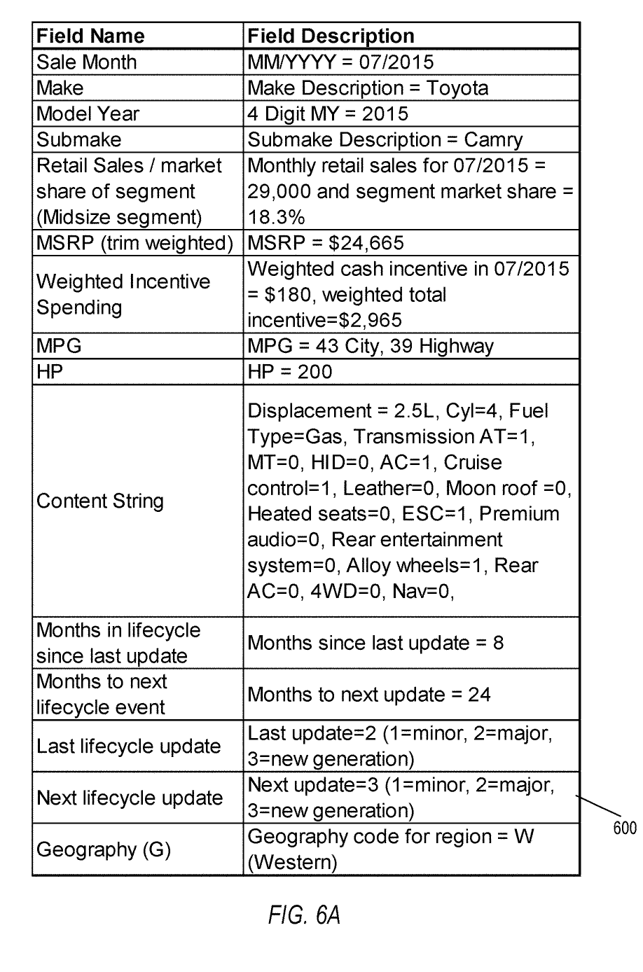

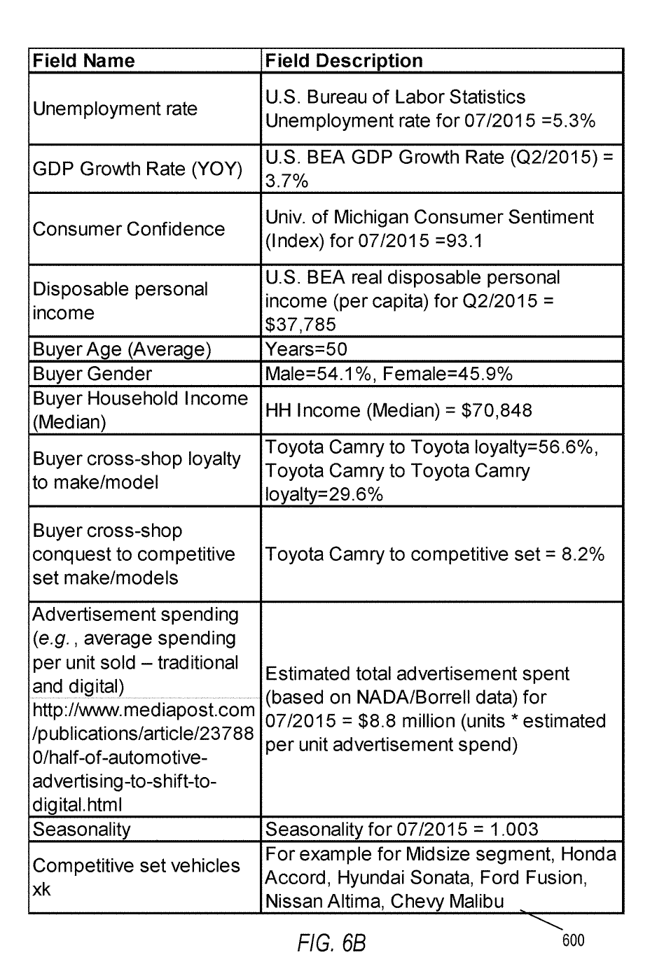

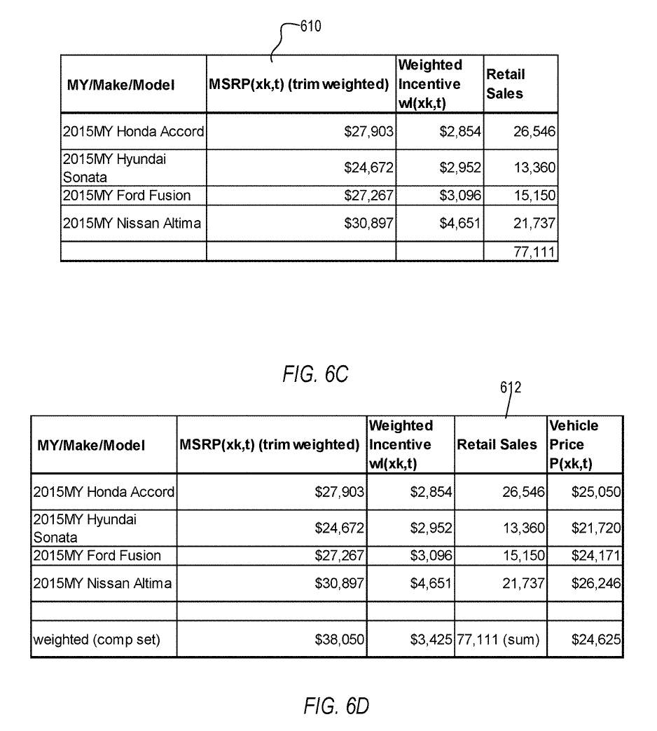

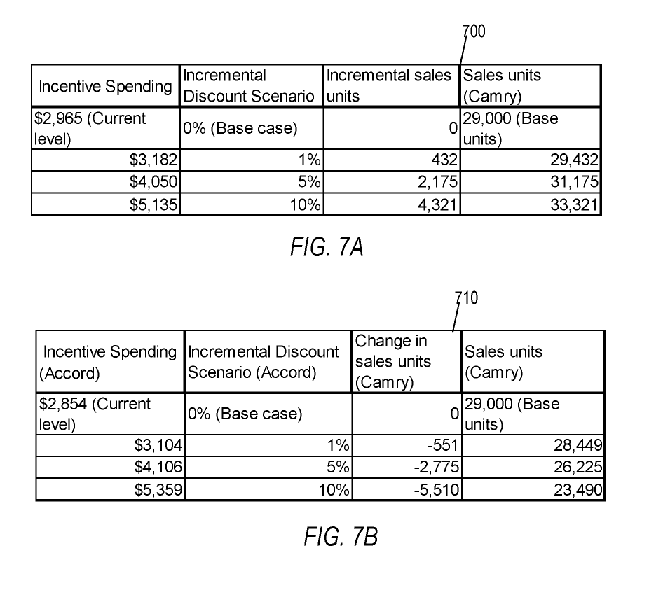

To help further illustrate systems and methods as disclosed herein, an example embodiment is discussed with respect to data sets illustrated in FIGS. 6A-6C and 7A-7B. For the purpose of illustration and not of limitation, the data sets include example sales, vehicle specific, transaction and other data. Although not listed here, it is assumed that the same data is available specific to vehicles in the competitive set and other vehicles.

Referring briefly to FIGS. 6A and 6B, a data set 600 which may be persisted in a vehicle data system data store is illustrated. Data set 600 provides one example embodiment of a set of hypothetical data set of obtained and processed data for a vehicle x, in this case a 2015MY Toyota Camry. Similar data sets may be maintained for a large number of vehicles. FIG. 6C illustrates a hypothetical data set 610 for competitive set vehicles for the same time period. In data sets 600 and 610, the incentives for the time period are already weighted for the time period. The demand model Q_{x,t} for the 2015 Toyota Camry may be developed using similar data sets for various historical periods.

The model level vehicle price for a 2015 model year Toyota Camry can be determined based on the MSRP, which may be trim weighted, in period t and the weighted incentives in period t.

$${P}_{x , t} = {MSRP}_{x , t} - {\sum }_{i = 1}^{I} {wI}_{x , t}$$

$${P}_{x , t} = \$24 , 665 - \$2 , 965 = \$21 , 700$$

Given a price P_{x,t} the demand for a 2015MY Toyota Camry can be determined using the demand model developed for that model of vehicle according to:

$$f ( x ) = {Q}_{x , t} = a + {β}_{1} {P}_{x , t} + {\sum }_{k = 1}^{K} {β}_{2} {P}_{xk , t} + {\sum }_{m = 1}^{M} {β}_{3} {E}_{t} + {\sum }_{v = 1}^{V} {β}_{4} {V}_{xt} + {\sum }_{vk = 1}^{Vk} {β}_{5} {V}_{xk , t} + {\sum }_{i}^{N} {\sum }_{p = 1}^{m} {β}_{6} {B}_{i , p , x , t} + {β}_{7} {A}_{x , t} + {β}_{8} {S}_{x , t} + {\sum }_{ℊ = 1}^{G} {β}_{9} {G}_{x , t} + e$$

For example Q_{2015 MY Camry,t} may=29,000 units or 18.3% market share.

Furthermore, using data set 610 for the competitive set vehicles, the price P_{xk,t} for the competitive vehicle set can be determined as illustrated by the enhanced data set 612 illustrated in FIG. 6D. The price P_{xk,t} for a vehicle in the competitive vehicle set can be determined according to:

$${P}_{xk , t} = {MSRP}_{xk , t} - {\sum }_{i = 1}^{I} {wI}_{xk , t}$$

Using the example of the Honda Accord from FIG. 6D:

P_{xk,t}=$27,903−$2,854=$25,050

Data set 612 also illustrates that a weighted MSRP and incentives can be determined for the competitive set.

Using the demand model, the price elasticity of demand (PED) for the 2015 model year Toyota Camry can be determined. For example, a P_{x,t} may be reduced by 1% ($217 dollars in this example) and the model run to predict that demand will correspondingly increase by 432 units. The PED can be determined as:

$${ɛ}_{px , t} = \frac{\frac{{dQ}_{x , t}}{{Q}_{x , t}}}{\frac{{dP}_{x , t}}{{P}_{x , t}}} = - 1.49 = \frac{\frac{432}{29 , 000}}{\frac{- 217}{21 , 700}}$$

While this example shows demand as sales units, PED can also be determined using market share as the measure of demand. Furthermore, as would be appreciated by those in the art, the PED can be applied to a sales target to determine the change in price required to meet that sales target.

The response in demand based on change in vehicle price of the 2015 model year Toyota Camry may also be determined for other incentive levels using the PED determined on the demand model. In the example below, a 5% incremental discount in vehicle price is used, which for a vehicle price of $21,700, is $1,085, which corresponds to incentives of $2,965+$1,085=$4,050. Here, it is assumed that the change in vehicle price is due to a corresponding change in incentive spending (discount)—a one-to-one relationship. The change in demand may be expressed as a percentage.

$$\frac{{dQ}_{x , t}}{{Q}_{x , t}} = \frac{{dP}_{x , t}}{{P}_{x , t}} {ɛ}_{px , t} = \frac{- 1 , 085}{21 , 700} ⋆ - 1.49 = 7.5 \%$$

Change in demand may also be expressed as the number of units. For a baseline demand of 29,000 units, the change in demand will be:

$$= {Q}_{x , t} ( \frac{{dP}_{x , t}}{{P}_{x , t}} {ɛ}_{px , t} ) = {Q}_{x , t} ( 1 + ( \frac{d ( {\sum }_{i = 1}^{I} {wl}_{x , t} )}{( {MSRP}_{x , t} - {\sum }_{i = 1}^{I} {wI}_{x , t} )} {ɛ}_{px , t} ) ) = 29 , 000 ⋆ ( 7.5 \% ) = 2 , 175 units .$$

By repeating these calculations with other discount levels, various incentive levels for the 2015 model year Toyota Camry and the resulting number of units demanded may be determined. Thus, the PED may be used to predict the effects of various incentives on demand or the incentives required to reach a particular sales target.

FIG. 7A illustrates one embodiment of a response in sales unit demanded data set 700 including various example levels of incentives for the 2015 Toyota Camry and related demand data. Similar response in demand data sets can be developed for various vehicles x.

Data set 700 provides incentive levels for vehicle x that are optimized in a non-user segment specific manner. However, if desired, one or more of these incentive levels may be associated with a user segment to provide targeted incentives. Vehicle models may be mapped to particular incentive levels and these incentive levels may further be mapped to user segments, which, in some embodiments correspond to user behaviors, such as browsing a specific incentivized vehicle model on the website, browsing a competitive model, prospecting on an incentivized model, prospecting on a competitive model, no purchase is made after N days, etc. Incentive levels can be particularly mapped to vehicle models by using mapping codes which may be assigned to match vehicle models with incentive levels. On an ongoing basis, the mapping can be maintained as new vehicle models show up and discontinued models drop off. User segments may be matched to incentives similarly with mapping codes where, for example, segment A gets incentive y. Data gathered from this process can be analyzed and dollar values and incentive levels adjusted periodically, for instance, on a monthly basis.

In addition, the cross-price elasticity of demand (cross-PED) for a vehicle in the competitive vehicle set k at time t can be determined. This may be represented as the demand response to vehicle price change of a vehicle of the competitive set for the 2015 model year Toyota Camry. In this example, a 1% reduction in vehicle price P_{xk,t} for the 2015 MY Honda Accord is used, which in the hypothetical data set of FIG. 6D has a P_{xk,t} of $20,050. In this example, the demand model predicts that 551 fewer 2015 Camry's will be sold for a 1% reduction in Honda Accord price.

$${ɛ}_{pxk , t} = \frac{\frac{{dQ}_{x , t}}{{Q}_{x , t}}}{\frac{{dP}_{xk , t}}{{P}_{xk , t}}} = 1.90 = \frac{\frac{- 551}{29 , 000}}{\frac{- 250}{25 , 050}}$$

While this example shows demand as sales units, cross-PED can also be determined using market share as the measure of demand.

Turning to FIG. 7B, the response in demand for the 2015 model year Toyota Camry based on change in vehicle price of a 2015 model year Honda Accord may then be determined. For example, a 5% discount may be applied to the vehicle price of $25,050 from FIG. 6D, which is $1,252 (which corresponds to incentives of $2,854+$1,252=$4,106). Again, it is assumed that the change in vehicle price has a one-to-one relationship to a corresponding change in incentive spending.

For a baseline demand of 29,000 units and using the cross-P ED determined for the Honda Accord above, the change in demand for the 2015 Toyota Camry is then:

$$= {Q}_{x , t} ( \frac{{dP}_{xk , t}}{{P}_{xk , t}} {ɛ}_{pxk , t} ) = {Q}_{x , t} ( \frac{d ( {\sum }_{i = 1}^{I} {wl}_{xkA , t} )}{( {MSRP}_{xk , t} - {\sum }_{i = 1}^{I} {wI}_{xk , t} )} {ɛ}_{pxk , t} ) = 29 , 000 ⋆ ( - 9.5 \% ) = - 2 , 755 units$$

By repeating these calculations with other discount levels, a response in demand based on competitive vehicle pricing data set can be developed. FIG. 7B, for example, illustrates one example embodiment of a response in demand based on competitive vehicle pricing data set 710 that may be persisted in a vehicle data system data store. As illustrated, the data set 710 includes various incentive levels for a vehicle in the competitive vehicle set, and the response in sales units demanded for vehicle x. This process can be repeated for each vehicle in the competitive set to develop similar data sets. Data set 710 may be used to guide levels of incentives to provide to user's who look at a competitive product (e.g., the Honda Accord).

In some embodiments, system 500 may apply incentive selection rules to automatically apply incentive levels based on the demand response data sets. According to another embodiment, the data sets 700 and 710 may be presented to an OEM data operator (e.g., a Toyota data operator) through an OEM portal (e.g., website) or other channel such that the OEM data operator may select which incentives to apply to vehicle x. These incentives may be persisted as incentive levels for the vehicle x. In addition, an OEM data operator may provide or select via the interface business rules for providing the incentives, such as selecting segments of users to receive the incentives. The segments of users may be predefined and provided to the OEM data operator through the OEM portal. The selected segments may be mapped to an incentive level particularly mapped to the vehicle model using mapping codes.

In another embodiment, information on a vehicle x may be displayed in an OEM portal with user controls (sliders, menus, etc.) linked to one or more variables used to determine demand response. For example, a web based control can be provided to adjust an incremental discount percentage of vehicle x or a vehicle xk in the competitive vehicle set. The system 500, using a pre-calculated demand model and or a pre-calculated PED and cross-PED, can determine the demand responses in real-time and present the demand responses to the OEM data operator. The OEM portal may provide a control, such as a selection button, so that the OEM data operator may select a currently displayed incentive level as an incentive level that should be persisted for vehicle x in the vehicle data system data store. The OEM portal may also provide the option for the OEM data operator to select the segments to which the incentives should apply.

In prior examples, the determination of optimized incentive levels is based on using specified incremental changes in incentive spending. In some embodiments, an OEM data operator may input desired sales goals (e.g., market share, units) and system 500 can use the PED to predict the necessary change in incentive spending to achieve those sales goals.

Incentive levels selected via the OEM portal may be particularly mapped to the vehicle model (e.g., 2015MY Toyota Camry) by using mapping codes which may be assigned to match vehicle models with incentive levels. Thus, for example, if the OEM data operator selects via the OEM portal, the current incentive level, the 1 incremental discount level and the 5% incremental discount, incentives of $2,965, $3,182, and $4,050 can be persisted in the vehicle data system data store in association with the 2015MY Toyota Camry. If the OEM data operator selects segments to which the incentives should be targeted, associations can be created in the vehicle data store between the incentives that are particularly mapped to the 2015MY Toyota Camry and the segments as specified via the OEM portal.

As noted above, the results of the foregoing operations are not segment-specific, though they may be associated with segments for targeted incentive allocation if so desired. In some embodiments, system 500 may further tune incentives to segments. The segments to which incentives are tuned may be defined by an administrator or other privileged user of the vehicle data system. In other embodiments system 500 may determine potential segments for use in targeting incentives (operation 540).

In some embodiments, system 500 may determine user segments based at least in part on data collected via the website, historical transaction records and other data (operation 540). A user segment may be a group of users having similar behaviors or characteristics (e.g., price, drive distance, vehicle colors, geographic resolution such as zip code, and/or user-specific data such as household income, social-economic status, etc.). Identifying or determining the user segments may be done using observable features representing and/or relating to these characteristics. Values for observable features may be obtained via a website supported by system 500, for instance, using user input provided via the website and/or information relating to aforementioned characteristics collected by the website.

Segmenting or segmentation refers to a process of grouping users (e.g., buyers, customers, website visitors, etc.) of the website into groups based on similarities. Clustering refers to a process of finding similarities in these users so that they can be grouped (and hence segmented). Clustering finds the relationship between data points so they can be segmented. System 500 may implement clustering on data associated with users to discover potential segments of users and their buying behavior to thereby enable system 500 to allocate incentives in a much more targeted, effective, and efficient manner. Skilled artisans will appreciate that system 500 may be configured for performing clustering using machine learning and algorithms to identify how different types of data are related and creating new segments based on those relationships.

A non-limiting example clustering methodology for user segmentation will now be described. Skilled artisans can appreciate that other clustering and segmentation methodologies may also be implemented or adapted to determine user segments.

According to one embodiment, a user who purchases a vehicle x (a buyer), bᵢ, can be described by a set of features f=1, 2, . . . ,m (e.g., buyer age, income, gender, cross-shop preferences, brand loyalty, etc.). These features may be collected via a website and from data provided by third parties, such as transaction data provided by dealers. This set may be defined as:

bᵢ={_{i,1}, b_{i,2}, . . . , b_{i,m}}

System 500 may represent all N distinct buyers in matrix form as:

$$[ \begin{matrix}{b}_{1 , 1} & {b}_{1 , 2} & … & {b}_{1 , m - 1} & {b}_{1 , m} \\ {b}_{2 , 1} & {b}_{2 , 2} & … & {b}_{2 , m - 1} & {b}_{2 , m} \\ ⋮ & ⋮ & ⋱ & ⋮ & ⋮ \\ {b}_{N - 1 , 1} & {b}_{N - 1 , 2} & … & {b}_{N - 1 , m - 1} & {b}_{N - 1 , m} \\ {b}_{N , 1} & {b}_{N , 2} & … & {b}_{N , m - 1} & {b}_{N , m}\end{matrix} ]$$

The similarity between buyer i and buyer j based on a comparison of observable features F can be computed using the Minkowski metric. Although the format of the data for some features may not be numeric, similarity can still be established across individual observable features f by first transforming the data to a numeric scale. U.S. Pat. No. 9,508,084, issued Nov. 29, 2016, entitled “SYSTEM, METHOD AND COMPUTER PROGRAM PRODUCT FOR PREDICTING ITEM PREFERENCE USING REVENUE-WEIGHTED COLLABORATIVE FILTER,” which is fully incorporated by reference herein for all purposes, describes, for example, methods for mapping binary, ordinal and categorical data to a numeric scale.

The user similarities based on observable features may be defined as:

$${si}_{ij} = 1 - {[ {\sum }_{f = 1}^{F} {W}_{f} {\vert {b}_{i , f} - {b}_{j , f} \vert}^{λ} ]}^{1 / λ}$$

where π≧0, 0≦siᵢⱼ≦1, and Σ_{f=1}^{F} w_{f}=1.

At time period tₙ, the system can determine a similarity for every pair of the N observations in the data set B, Bᵢ≠Bⱼ, then an N×N matrix of similarities, siₙ, can be determined. There is no need to compute the values of sᵢᵢ since the similarity between an observation and itself is, by definition, 1.

With a subtraction from an N×N identity matrix, the dissimilarities can be determined (S̅t̅ₙ=1−siₙ) and used to build segments at time tₙ comprised of K distinct sets of buyers, U_{k,n} (k=1, . . . , K). Using s̅t̅ₙ, the system may employ any one of a variety of hierarchical clustering methods to partition the observations into distinct sets of users. For example, if the K-means clustering method is employed, system 500 can partition the data into K clusters by maximizing the within-cluster variation. If a cluster is indexed by k containing nₖ observations, the overall within-cluster variance σ_{w}² based on a clustering outcomes may be defined as:

σ_{w}²=Σₖ₌₁^{K} Σ_{f=1}^{F} Σᵢ₌₁ⁿ^{_{f}}(b_{(k)k,f}−b̅_{(k(j,f})².

Various other clustering methods may be used. When the number of observations, N, is large, one may benefit from using the K-means clustering method after reprojecting S̅ₙ into an Q-dimensional set of points on a scale that preserves the dissimilarities that are invariant to translation and rotation.

In a K-means clustering implementation, system 500 may: (1) select a value for K, (2) define K cluster centers (which may be done randomly), (3) determine the class memberships of the N objects (representing users, in this example) by assigning them to the nearest cluster center, (4) re-estimate the K cluster centers by assuming the memberships found above are correct, and (5) if none of the N objects changed membership in the last iteration, exit. Otherwise, return to (3) and repeat (3)-(5). There are a number of methods known in the art to select a value for K for K-means clustering. By way of example, but not limitation, K may be the square root of the sample size divided by two. In addition to various rules to select K, heuristic approaches may also be used.

The overall variance σ² of the clustering outcome, in this example, is the sum of the within-cluster σ_{w}² and between-cluster σ_{b}² variances:

σ²=σ_{w}²+σ_{b}²

At this point, users known to system 500 (e.g., based on collected data) are clustered into segments (or clusters). A statistical analysis can be employed to determine how many clusters should be used. By way of example, but not limitation, the Calinski-Harabasz index may be used:

$$\frac{{σ}_{b}^{2} / ( K - 1 )}{{σ}_{w}^{2} / ( N - K )}$$

Since the variables used to compute similarity may be time-dependent, the competitive set of users can be recomputed at every time period, tₙ. At the end of this process, every buyer bᵢ i, . . . , I belongs to one-and-only-one set of the K distinct sets of buyers, U_{k,n}. Each distinct set of buyers U_{k,n} represents a potential segment.

To accurately allocate/adjust incentives for associated user clusters or segments, system 500 may determine the PED and cross-PED for specific clusters or segments using the demand model for a vehicle x.

According to one embodiment a (potential) segment Siᵢⱼ is a buyer segment of buyers i=1,2, . . . N, such that:

Siᵢⱼ=Σₚ₌₁^{m} B_{ij,p,x,t}

The PED based on change in vehicle price Pₓ of vehicle x in time t and based on specific user cluster or segment Siᵢⱼ

$${ɛ}_{px , t\_Siij} = \frac{\frac{{dQ}_{x , t}}{{Q}_{x , t}}}{\frac{{dP}_{x , t}}{{P}_{x , t}}} = \frac{\begin{matrix}d ( a + {β}_{1} {P}_{x , t} + {\sum }_{k = 1}^{K} {β}_{2} {P}_{xk , t} + {\sum }_{m = 1}^{M} {β}_{3} {E}_{t} + {\sum }_{v = 1}^{V} {β}_{4} {V}_{xt} + \\ \frac{{\sum }_{vk = 1}^{Vk} {β}_{5} {V}_{xk , t} + {\sum }_{i}^{N} {\sum }_{p = 1}^{m} {β}_{6} {B}_{ij , p , x , t} + {β}_{7} {A}_{x , t} + {β}_{8} {S}_{x , t} + {\sum }_{ℊ = 1}^{G} {β}_{9} {G}_{x , t ,} + e )}{\begin{matrix}( a + {β}_{1} {P}_{x , t} + {\sum }_{k = 1}^{K} {β}_{2} {P}_{xk , t} + {\sum }_{m = 1}^{M} {β}_{3} {E}_{t} + {\sum }_{v = 1}^{V} {β}_{4} {V}_{xt} + {\sum }_{vk = 1}^{Vk} {β}_{5} {V}_{xk , t} + \\ {\sum }_{p = 1}^{m} {β}_{6} {B}_{ij , p , x , t} + {β}_{7} {A}_{x , t} + {β}_{8} {S}_{x , t} + {\sum }_{= 1}^{G} {β}_{9} {G}_{x , t} + e )\end{matrix}}\end{matrix}}{\frac{d ( {MSRP}_{x , t} - {\sum }_{i = 1}^{I} {wI}_{x , t} )}{( {MSRP}_{x , t} - {\sum }_{i = 1}^{I} {wI}_{x , t} )}}$$

The PED may be determined by selecting a change in P_{x,t} of a selected amount, say 1%, to determine the change in demand based on the demand model using the buyer set Bᵢⱼ.

System 500 may also determine the cross-price elasticity of demand (cross-PED) for a competitive vehicle set k at time t based on cluster or segment. The cross-PED of vehicle x in time t compared to change of vehicle price of vehicles of competitive set xk for a user cluster or segment may be defined as:

$${ɛ}_{pxk , tSiij} = \frac{\frac{{dQ}_{x , t}}{{Q}_{x , t}}}{\frac{d ( {P}_{xk , t} )}{( {P}_{xk , t}}} = \frac{\begin{matrix}d ( a + {β}_{1} {P}_{x , t} + {\sum }_{k = 1}^{K} {β}_{2} {P}_{xk , t} + {\sum }_{m = 1}^{M} {β}_{3} {E}_{t} + {\sum }_{v = 1}^{V} {β}_{4} {V}_{xt} + \\ \frac{{\sum }_{vk = 1}^{Vk} {β}_{5} {V}_{xk , t} + {\sum }_{i}^{N} {\sum }_{p = 1}^{m} {β}_{6} {B}_{ij , p , x , t} + {β}_{7} {A}_{x , t} + {β}_{8} {S}_{x , t} + {\sum }_{ℊ = 1}^{G} {β}_{9} {G}_{x , t ,} + e )}{\begin{matrix}( a + {β}_{1} {P}_{x , t} + {\sum }_{k = 1}^{K} {β}_{2} {P}_{xk , t} + {\sum }_{m = 1}^{M} {β}_{3} {E}_{t} + {\sum }_{v = 1}^{V} {β}_{4} {V}_{xt} + {\sum }_{vk = 1}^{Vk} {β}_{5} {V}_{xk , t} + \\ {\sum }_{p = 1}^{m} {β}_{6} {B}_{ij , p , x , t} + {β}_{7} {A}_{x , t} + {β}_{8} {S}_{x , t} + {\sum }_{ℊ = 1}^{G} {β}_{9} {G}_{x , t} + e ) \end{matrix}}\end{matrix}}{\frac{d ( {MSRP}_{xk , t} - {\sum }_{i = 1}^{I} {wI}_{xk , t} )}{( {MSRP}_{xk , t} - {\sum }_{i = 1}^{I} {wI}_{xk , t} )}}$$

System 500 may further tune incentive levels for a vehicle to user segments (operation 560). More particularly, the response in demand (change in %) based on change in vehicle price Pₓ (solely incentive) of vehicle x in time t and based on specific user cluster or segment

$${Si}_{ij} = {\sum }_{p = 1}^{m} {B}_{ij , p , x , t}$$

may be defined as:

$$\frac{{dQ}_{x , t}}{{Q}_{x , t}} = \frac{{dP}_{x , t}}{{P}_{x , t}} {ɛ}_{px , t\_Siij} = \frac{d ( {\sum }_{i = 1}^{I} {wI}_{x , t} )}{( {MSRP}_{x , t} - {\sum }_{i = 1}^{I} {wI}_{x , t} )} {ɛ}_{px , t\_Siij} .$$

The change in units demanded based on change in vehicle price Pₓ (solely incentive) of vehicleₓ in timeₜ and based on specific user cluster or segment Siᵢⱼ=Σₚ₌₁^{m} B_{ij,p,x,t} may be defined as:

$$= {Q}_{x , t} ( \frac{{dP}_{x , t}}{{P}_{x , t}} {ɛ}_{px , t\_Siij} ) = {Q}_{x , t} ( \frac{d ( {\sum }_{i = 1}^{I} {wI}_{x , t} )}{( {MSRP}_{x , t} - {\sum }_{i = 1}^{I} {wI}_{x , t} )} {ɛ}_{px , t\_Siij} ) .$$

The response in demand (change in %) based on change in vehicle price Pₓₖ (solely incentive) of vehicles of competitive set xk in time t and based on specific user cluster or segment may be defined as:

$$\frac{{dQ}_{x , t}}{{Q}_{x , t}} = \frac{{dP}_{xk , t}}{{P}_{xk , t}} {ɛ}_{px , t\_Siij} = \frac{d ( {\sum }_{i = 1}^{I} {wI}_{xk , t} )}{( {MSRP}_{xk , t} - {\sum }_{i = 1}^{I} {wI}_{xk , t} )} {ɛ}_{px , t\_Siij}$$

The change in units demanded based on change in vehicle price Pₓₖ of a vehicle of competitive set xk in time t based solely on incentives may be defined as:

$$= {Q}_{x , t} ( \frac{{dP}_{xk , t}}{{P}_{xk , t}} {ɛ}_{px , t\_Siij} ) = {Q}_{x , t} ( \frac{d ( {\sum }_{i = 1}^{I} {wI}_{xk , t} )}{( {MSRP}_{xk , t} - {\sum }_{i = 1}^{I} {wI}_{xk , t} )} {ɛ}_{px , t\_Siij} )$$

Returning briefly to the example of the 2015MY Toyota Camry, system 500 may thus develop data sets similar to data sets 700 and 710 (FIG. 7A and FIG. 7B). The incentive levels in these data sets are tuned to the specific segment and vehicle x.

By determining the PED, cross-PED and/or responses in demand for various clusters, system 500 can identify the segments of consumers that need the smallest price signal in order to transact. System 500 can then automatically update incentive levels and segment associations for a vehicle to serve incentives of differing amounts to these consumers, such that the average incentive level is minimized for each vehicle model.

System 500 may implement segment selection rules to identify segments or potential segments from the user clusters based, for example, on the segment specific PED, cross-PED or demand responses. As an example, a cluster that exhibits a PED that is greater than a threshold amount (e.g., absolute or percentage wise) different than the non-segment specific PED may be identified as a potential segment to which segment tuned incentives should be targeted. For example, if a cluster corresponding to college students demonstrates a higher sensitivity to price for the 2015MY Camry, the vehicle data system may suggest in the OEM portal that the college student segment is a potential segment to which incentives should be targeted. In addition, system 500 may provide demand response data for the college student segment to guide selection of incentives specifically tuned to the college student segment.

Segment specific segment levels may be automatically selected and applied. In another embodiment, an OEM data operator may access the demand response data via an OEM portal as discussed above with respect to the non-segment specific incentives and select incentive levels to apply to a vehicle x.

Thus, according to one embodiment, a method for determining incentive levels for user segments may include establishing a demand Q for motor vehicle x and its competitive set. This allows the system to properly gauge the strength/weakness of demand Q. The method may further comprise deriving a price elasticity of demand (PED) and cross-elasticity of demand for vehicle x and competitive set xk. This allows the system to understand the sensitivity of price changes to quantity demanded. Based on price elasticity of demand of vehicle x and knowing a particular manufacturer's goals of incremental sales, incentive levels can be adjusted to reach this goal. The method may further comprise identifying user cluster/segmentations and determining segment specific incentive levels fine-tuned to particular user clusters to optimize incentive spending.

An adaptive incentive allocation method implemented on system 500 using behavioral analytics described above may comprise an offline process (backend) and an online (frontend) process. FIG. 8A illustrates example offline process 800, FIG. 8B illustrates example online process 801 and FIG. 8C illustrates another example on-line process 802. As an example, offline process 800 may comprise obtaining data from one or more sources (step 810). Data thus obtained by offline process 800 may include MSRP, dealer and customer cash incentives by date, ZIP Code and vehicle trim. For example, referring to FIG. 1, data may be obtained periodically (per a job schedule, for instance) from one or more of dealers 130, sales data companies 160, DMVs 180, OEMs 150, financial institutions 182, inventory companies 140, and external sources 184.

Initially, data can be obtained from one or more of the data sources coupled to the vehicle data system and the obtained data stored in a data store. The data obtained from these various data sources may be aggregated from the multiple sources and normalized. The various data sources and the respective data obtained from these data sources may include some combination of DMS data, inventory data, registration or other government (DMV, Sec. of State, etc.) data, finance data, syndicated sales data, incentive data, shipping cost data, upfront pricing data, OEM pricing data, manufacturer data, economic data and other data.

DMS data may be obtained from a DMS at a dealer. The DMS is a system used by vehicle dealers to manage sales, finance, parts, service, inventory or back office administration needs. Thus, data which tracks all sales transactions for both new and used cars sold at retail or wholesale by the dealer may be stored in the DMS and obtained by the vehicle data system. In particular, this DMS data may comprise data on sales transactions which have been completed by the dealer (referred to as historical sales transactions), including for example, an identification of a vehicle's VIN, make, model, trim, etc., data of purchase, geographic location of purchase, purchase price, optional services purchased, optional equipment purchased, identity of the dealership, identity of the purchaser, demographic data related to the purchaser, dealership costs associated with a particular transaction or the like. As most DMS are Active Server Pages (ASP) or Java Server Pages (JSP) based, in some embodiments the sales transaction or other DMS data can be obtained directly from the DMS or DMS provider utilizing a “key” (for example, an ID and Password with set permissions) that enables the vehicle data system or DMS polling companies to retrieve the DMS data, which in one embodiment, may be obtained on a daily or weekly basis.

Inventory data may be detailed data pertaining to vehicles historically or currently within a dealer's inventory, or which will be in the dealer's inventory at some point in the future. Inventory data can be obtained from a DMS, inventory polling companies, inventory management companies or listing aggregators. Inventory polling companies are typically commissioned by a dealer to pull data from the dealer's DMS and format the data for use on websites and by other systems. Inventory management companies manually upload inventory information (for example, photos, descriptions, specifications, etc. pertaining to a dealer's inventory) to desired locations on behalf of the dealer. Listing aggregators may get data by “scraping” or “spidering” websites that display a dealer's inventory (for example, photos, descriptions, specifications, etc. pertaining to a dealer's inventory) or receive direct feeds from listing websites (for example, FordVehicles.com).

Registration or other government data may also be obtained. When a buyer purchases a vehicle it must be registered with the state (for example, DMV, Secretary of State, etc.) for tax, titling or inspection purposes. This registration data may include vehicle description information (for example, model year, make, model, mileage, etc.) and a sales transaction price which may be used for tax purposes. Thus, this data may also include historical transaction data.

Finance and agreement data may also be obtained. When a buyer purchases a vehicle using a loan or lease product from a financial institution, the loan or lease process usually requires two steps: applying for the loan or lease and contracting the loan or lease. These two steps utilize vehicle and consumer information in order for the financial institution to properly assess and understand the risk profile of the loan or lease. This finance application or agreement data may also be obtained at step. In many cases, both the application and agreement include proposed and actual sales prices of the vehicle.

Embodiments of the vehicle data system may also be configured to obtain syndicated sales data. Syndicated sales data companies aggregate new and used sales transaction data from the DMS of dealers associated with a particular network of dealers (e.g., TrueCar dealer network) or with whom they are partners or have a contract. These syndicated sales data companies may have formal agreements with dealers that enable them to retrieve transaction data in order to syndicate the transaction data for the purposes of analysis or purchase by other data companies, dealers or OEMs. Accordingly, this data may also include historical transaction data.

Incentive data can also be obtained by the vehicle data system. OEMs use manufacturer-to-dealer and manufacturer-to-consumer incentives or rebates in order to lower the transaction price of vehicles or allocate additional financial support to the dealer to help stimulate sales. As these rebates are often large (2%-20% of the vehicle price) they can have a dramatic effect on vehicle pricing. These incentives can be distributed to consumers or dealers on a targeted basis as discussed above. This incentive data can be obtained from OEMs, dealers or another source altogether such that it can be used by the vehicle data system to determine accurate transaction, or other, prices for specific vehicles.

As dealers may have the opportunity to pre-determine pricing on their vehicles it may also be useful to configure the vehicle data system to obtain this upfront pricing data. Companies like Zag.com Inc. enable dealers to input pre-determined, or upfront, pricing to consumers. This upfront price is typically the “no haggle” (price with no negotiation) price. Many dealers also present their upfront price on their websites and even build their entire business model around the notion of “no negotiation” pricing. These values may be used for a variety of reasons, including determination of pricing likelihoods, providing a check on the transaction prices associated with obtained historical transaction data. In one embodiment, this upfront pricing data may include upfront prices for a set of vehicle dealers. These vehicle dealers may be all the dealers associated with a particular network of dealers (e.g., TrueCar dealer network) such that the upfront pricing offered by these dealers can be presented in association with vehicle data through the vehicle data system as described in U.S. Pat. No. 7,945,483 issued May 17, 2011 to Inghelbrecht et al. which is incorporated herein by reference in its entirety.

Additionally, the vehicle data system may be configured to obtain OEM pricing data. This OEM pricing data may provide important reference points for the transaction price relative to vehicle and dealer costs. OEMs usually set two important numbers in the context of vehicle sales, invoice price and MSRP (also referred to as sticker price) to be used as general guidelines for the dealer's cost and price. These are fixed prices set by the manufacturer and may vary slightly by geographic region. The invoice price is what the manufacturer charges the dealer for the vehicle. However, this invoice price does not include discounts, incentives, or holdbacks which usually make the dealer's actual cost lower than the invoice price. According to the American Automobile Association (AAA), the MSRP is, on average, a 13.5% difference from what the dealer actually paid for the vehicle. Therefore, the MSRP is almost always open for negotiation. An OEM may also define what is known as a dealer holdback, or just a holdback. Holdback is a payment from the manufacturer to the dealer to assist with the dealership's financing of the vehicle. Holdback is typically a percentage (2 to 3%) of the MSRP.

Although the MSRP may not equate to an actual transaction price, an invoice price can be used to determine an estimate of a dealer's actual cost as this dealer cost is contingent on the invoice. In some embodiments, this dealer cost can be defined as invoice price less any applicable manufacturer-to-dealer incentives or holdbacks. The vehicle data system may therefore utilize the invoice price of a vehicle associated with a historical transaction to determine an estimate of the dealer's actual cost which will enable it to determine “front-end” gross margins (which can be defined as the transaction price less dealer cost and may not include any margin obtained on the “back end” including financing, insurance, warranties, accessories and other ancillary products).

Data may also be obtained from a wide variety of other data sources, including economic data related to the current, past or future state of almost any facet of the economy including vehicle demand, gas prices, demographic data such as household income, markets, locale(s), consumers, or almost any other type of data desired. The economic data may be specific to, or associated with, a certain geographic area. Additionally, this economic data may comprise an internet index, which may be determined from the average price for a vehicle as reported by certain Internet research sites as the average price for a vehicle. Although these Internet research sites are typically consumer focused, they sell advertising and leads to the automotive dealerships; therefore their paying customers are dealerships and the prices on these sites tend to represent the higher end of the scale, favoring dealerships.

Historical web demand data may also be obtained or tracked. This data may include data on searches or requests for particular vehicles or vehicle configurations, including, for example, tracked web log information, web statistics information, or other data that may be reflective or related to demand for a particular vehicle.

Other sources from which the vehicle data system may obtain data include manufacturer data, which may include manufacturers' suggested retail prices (MSRP), information about trim levels, color and VIN data which may be used as part of the data scrubbing process or elsewhere. The manufacturer data may thus include vehicle configurator data associated with a vehicle, such as, e.g., year, make, model, trim, color, equipment options, service options, and/or the like.

The vehicle data system may also obtain geographic shipping cost data, to factor for shipping cost variations, such as to markets outside the continental United States, including Hawaii, Alaska or Guam. Other sources of data may include news/weather, to provide notice of events that may bear on the volume or quality of purchase activity, such as heavy snowfalls.

Once the desired data is obtained, the vehicle data system may be configured to enhance the data by cleansing the data and optimizing or normalizing the data. The data may first be cleansed. In particular, the data obtained may not be useful if it is inaccurate, duplicative or does not conform to certain parameters. Therefore, the vehicle data system may cleanse obtained data to maintain the overall quality and accuracy of the data presented to end users. This cleansing process may entail the removal or alteration of certain data based on almost any criteria desired, where these criteria may, in turn, depend on other obtained or determined data or the evaluation of the data to determine if it conforms with known values, falls within certain ranges or is duplicative. When such data is found it may be removed from the data store of the vehicle data system, the values which are incorrect or fall outside a threshold may be replaced with one or more values (which may be known specifically or be default values), or some other action entirely may be taken.

In one embodiment, during this cleansing process a VIN decode may take place, where a VIN number associated with data (for example, a historical transaction) may be decoded. Specifically, every vehicle sold must carry a Vehicle Identification Number (VIN), or serial number, to distinguish itself from other vehicles. The VIN consists of 17 characters that contain codes for the manufacturer, year, vehicle attributes, plant, and a unique identity. Vehicle data system may use an external service to determine a vehicle's attributes (for example, make, model year, make, powertrain, trim, etc.) based on each vehicle's VIN and associate the determined vehicle information with the sales transaction from which the VIN was obtained. Note that in some cases, this data may be provided with historical transaction data and may not need to occur with respect to one or more of the historical transactions. Thus, the set of historical transactions in the historical transaction data may be enhance through this VIN decoding if needed to include data such as vehicle data associated with the VIN, including for example, vehicle configuration data, vehicle binning information, information associated with residence time of a particular vehicle on a dealer's lot, MSRP, or other information.

Additionally, inaccurate or incomplete data may be removed. In one embodiment, the vehicle data system may remove any historical transaction data that does not include one or more key fields that may be utilized in the determination of one or more values associated with that transaction (for example, vehicle make, model, trim, etc.). Other high-level quality checks may be performed to remove inaccurate (including poor quality) historical transaction data. Specifically, in one embodiment, cost information (for example, dealer cost) associated with a historical transaction may be evaluated to determine if it is congruent with other known, or determined, cost values associated with the make, model or trim of the vehicle to which the historical transaction data pertains. If there is an inconsistency (for example, the cost information deviates from the known or determined values by a certain amount) the cost information may be replaced with a known or determined value or, alternatively, the historical transaction data pertaining to that transaction may be removed from the data store.

In one embodiment, for each historical transaction obtained the following actions may be performed: verifying that the transaction price falls within a certain range of an estimated vehicle MSRP corresponding to the historical transaction (e.g., 60% to 140% of MSRP of the base vehicle); verifying that the dealer cost for the transaction falls within a range of an estimated dealer cost (e.g., 70% to 130% of invoice—holdback of the base vehicle); verifying that a total gross (front end+back end gross) for the historical transaction is within an acceptable range (e.g., −20% to 50% of the vehicle base MSRP); verifying that the type of sale (new/used) aligns to the number of miles of the vehicle (for example, more than 500 miles, the vehicle should not be considered new).

Cleansing the data may also involve duplicate data removal. As there may be many sources for historical transaction data in many cases duplicative historical transaction data may be obtained. As such duplicative data can skew the results of the output of the vehicle data system, it may be desired to remove such duplicate data. In cases where uniquely identifiable attributes such as the VIN are available, this process is straightforward (for example, VINs associated with historical transactions may be matched to locate duplicates). In cases where the transaction data does not have a unique attribute (in other words, an attribute which could pertain to only one vehicle, such as a VIN, a combination of available attributes may be used to determine if a duplicate exists). For example, a combination of sales date, transaction type, transaction state, whether there was a trade-in on the transaction, the vehicle transaction price or the reported gross may all be used to identify duplicates. In either case, once a duplicate is identified, the transaction data comprising the most attributes source may be kept while the duplicates are discarded. Alternatively, data from the duplicate historical transactions may be combined in some manner into a single historical transaction.

Outlier data can also be removed. Outlier data is defined as data that does not appear to properly represent a likely transaction. In one embodiment, historical transaction data pertaining to transactions with a high negative margin (dealer loses too much money) or a high positive margin (dealers appears to earn too much money) may be removed. Removing outlier data may, in one embodiment, be accomplished by removing outlier data with respect to national, regional, local or other geographic groupings of the data, as removing outlier data at different geographic level may remove different sets of transaction data. In addition, relative or absolute trimming may be used such that a particular percentage of the transactions beyond a particular standard deviation may be removed off of the top and bottom of the historical transactions.

Cleansed data may be stored in a data store associated with the vehicle data system, where the cleansed data includes a set of historical transactions, each historical transaction associated with at least a set of vehicle attributes (for example, make, model, engine type, trim, etc.), a transaction price or front end gross or price ratio, and the transaction date. Other data, such as geography (e.g., the actual dealer, the DMA, zip code, city, etc.), available incentives, inventory data, weather, or financial data associated with each transaction or transaction date may also be stored in the data store.

Using the (enhanced) collected potential segments can be identified and demand models, PED, cross-PED, demand responses can be developed, both on a non-segment specific and segment specific basis, such that incentives can be optimized including for specific user segments as described above with reference to FIG. 5 (step 820). Determined or selected targeted incentive levels for one or more vehicles x can be persisted (step 830).

FIG. 8B illustrates one embodiment of an online process 801. Online process 801 may comprise receiving a query from a data operator (e.g., via an OEM portal) for incentive information for a vehicle category (e.g., make model) (step 840). Incentive data, such as incentive amounts, incentive levels for vehicle x, response data and segment data, including segment specific incentive data, and segment data determined in the offline process 800 may be returned to the data operator (e.g., via one or more web pages) (step 850). The system may then receive a targeted incentive specification (step 860). The targeted incentive specification may include a selection of incentive levels and associated segments (step 865) for a vehicle x. The system can store the associations of different levels of incentives particularly mapped to the vehicle category with segments in the data store as active targeted incentives that may be targeted to users.

As shown in FIG. 8C, online process 802 may comprise receiving a query from a user device associated with a particular user via a website supported by the underlying system implementing offline process 802 (step 870). The user may be interested (and this interest can be ascertained from user behavior while the user is on the website, such as from the query) in a vehicle with the specific vehicle configuration. The vehicle may be presented to the user by the website (perhaps in response to a product search/research conducted on the website by the user) and carried by one or more dealers affiliated with the website, as described above.

The system may determine observable features of the user (step 875). The observable features may include information in the query and information collected by the website. Examples of observable features may be determined from information provided by a user via the website (e.g., age, geographic location, income, etc.) and vehicle configuration information (e.g., make, model, options, etc.), behavior information collected by the website and other information.

An incentive may be determined for the particular user based on the observable features of the user (step 880). More particularly, this may include applying segment matching rules to the observable features of the particular user to match one or more observable features of the user to a segment or determine a similarity between the observable features of the user and a segment. Determining an appropriate user segment for the particular user may thus be based at least in part on the observable features associated with the user including, but not limited to user characteristics (age, geographic location, income, etc.) or user behavior. Example user behaviors include, but are not limited to: providing a specific vehicle configuration, browsing a specific incentivized vehicle model on the website, browsing a competitive model, prospecting on an incentivized model, prospecting on a competitive model, downloading incentive certificates, accessing vehicle data system through a trusted affiliate website, etc.

For a specific incentivized vehicle model, there can be different incentive levels based on user segmentation that reflects user behavior or other observable features. An appropriate incentive level may be selected based on behavior or other observable features of the querying user that places the querying user in a particular segment corresponding (mapped) to that incentive level. The incentive level relative to the particular user behavior may have a particular dollar value for the specific incentivized vehicle model and different incentive levels for the same specific incentivized vehicle model have different dollar values associated therewith. Once the incentive has been determined for the particular user, the determined incentive may be presented to the particular user via the website (step 890).

In one embodiment, an incentive determined for a user can be presented as a viewable, and in some implementations downloadable, certificate containing a unique code generated for that certificate. In addition or in the alternative, vehicle pricing data may be returned with the price of the vehicle adjusted accordingly to show an “after the incentive” purchase price.

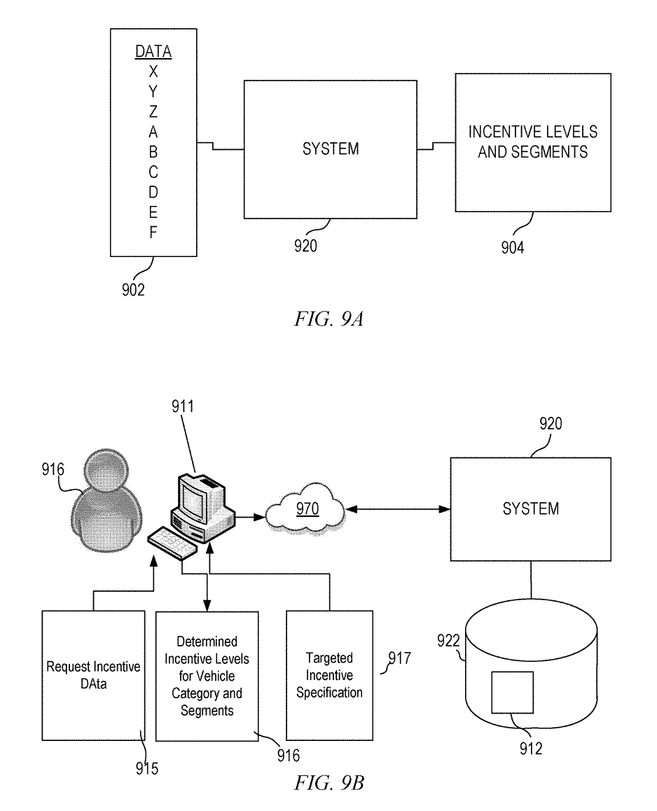

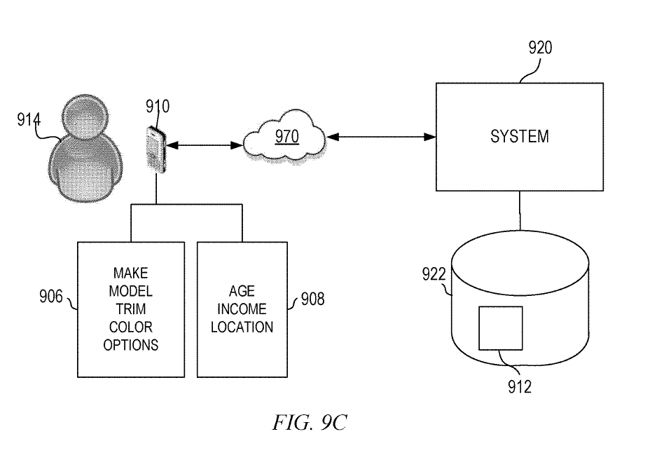

FIGS. 9A, 9B and 9C are a diagrammatic representations of a computer system 920 implementing offline process 800 as shown in FIG. 8A and online processes 801 and 802 as shown in FIGS. 8B and 8C.

In FIG. 9A, system 920 may receive or obtain data 902 from one or more sources. Data 902 may include information from past vehicle sales provided by dealers, financial institutions, and other data. System 920 may use data 902 to determine potential user segments and incentive levels for vehicles 904, including segment specific incentive levels and/or incentive levels that are not tuned to specific segments. The determined incentive levels and segments may be persisted in a data store (e.g., data store 922 shown in FIG. 9B).

As shown in FIG. 9B, a data operator 916 may use a client computing device 911 to access system 920 over network 970 via an OEM portal. System 920 may receive a request 915 for incentive information for a vehicle category (e.g., make/model). Incentive data 917, such as incentive amounts, incentive levels for a vehicle x, response data and segment data, including segment specific incentive data, and segment data may be returned to the data operator via an interface. The system 920 may then receive a targeted incentive specification 917 that specifies for a particular vehicle category, the segment level and segment associations that should be applied. The system 920 can store the associations of different levels of incentives particularly mapped to the vehicle category with segments in a data table 912. Data set 302 of FIG. 3 provides one embodiment of a data set that may be maintained in a data table 912 for targeted incentives.

As shown in FIG. 9C, a user may use a client computing device 910 to access system 920 over network 970 via a website. System 920 may receive observable features, such as a vehicle configuration 906 and user information 908, from user 914 via user device 910. System 920 may search data table 912 persisted on data storage 922 and, using the observable features, determine an appropriate user segment and corresponding incentive level for the user segment for a vehicle configuration. A dollar value associated with the incentive level thus determined may be presented to user 914 via the website (e.g., by displaying the incentive on user device 910 via a browser application running on user device 910 and communicatively connected to the website over a network connection).

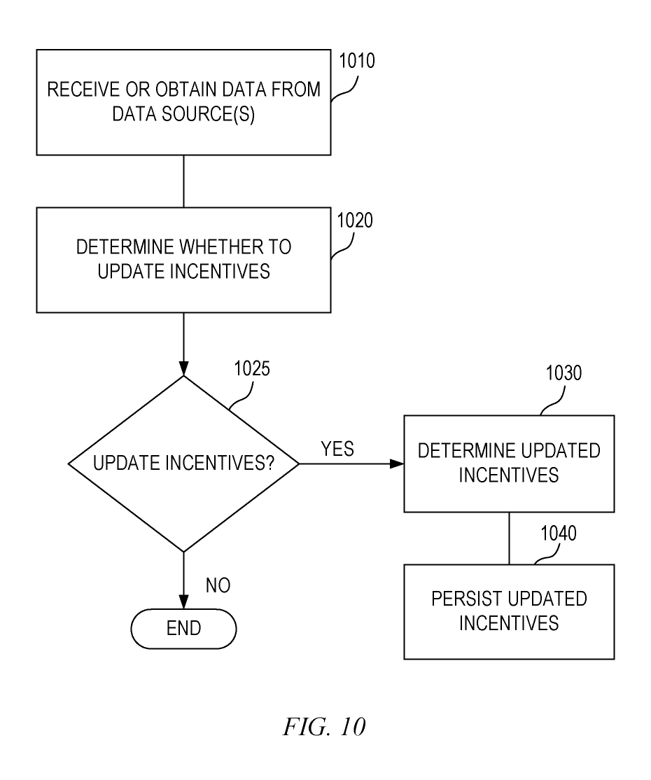

Over time, it may be desirable to update the incentives for a number of reasons. For example, more data may become available, vehicle preferences may change, etc. FIG. 10 is a flow chart illustrating one embodiment of an update process in accordance with some embodiments. The system may receive or obtain data from one or more sources (step 1010). In some embodiments, the system receives data pushed by the one or more data sources. In another embodiment, the system requests data from the one or more sources. The system may determine whether to update the incentives (step 1020). Determining whether to update the incentives may be performed responsive to new data received or obtained or may be performed as part of a scheduled update (e.g., daily, weekly, etc.).

If the system determines that the incentives do not need updated (step 1025), the process ends. If the system determines that the incentives do need updated, the system determines the updated incentive information (step 1030) using the updated data. Updating the incentives may include, for example, updating one or more demand models, PEDs, cross-PEDs or demand responses for one or more vehicles, presenting the updated incentive information and receiving selections of updated incentives and associated segments. The updated incentives may be persisted (step 1040). The update may be performed on all or only part of the incentives. The update may update any determined aspect of the determined incentive levels, such as user segments, the competitive vehicle set, etc.

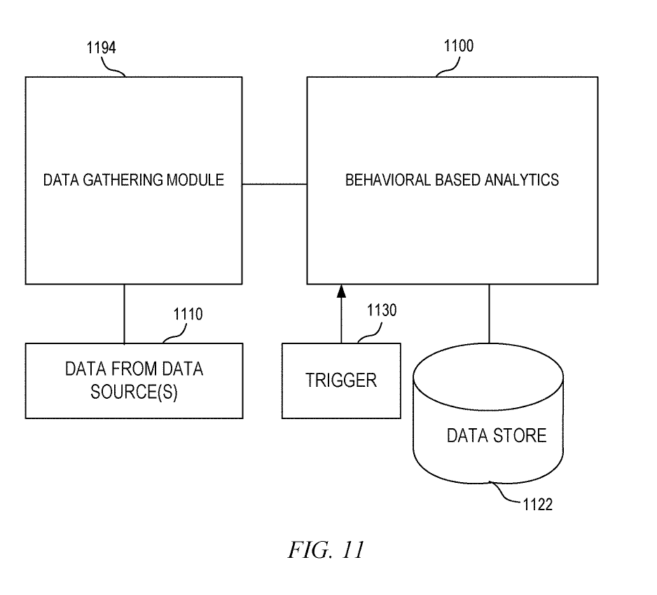

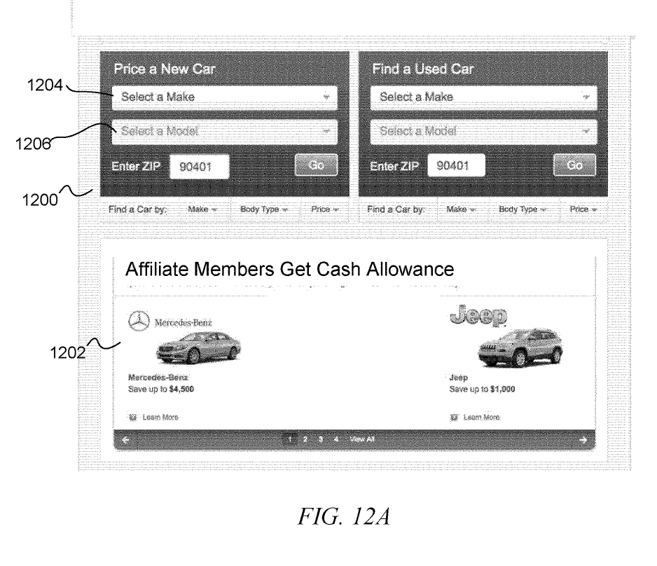

FIG. 11 is a diagrammatic representation of a system implementing an update process, such as the update process described above with reference to FIG. 10. In some embodiments, behavioral based analytics 1100 may update previously determined incentives responsive to trigger 1130. An example of a trigger may be a scheduled event to perform the update process. Another example of a trigger may be an instruction from a system administrator.

Upon receipt of trigger 1130, behavioral based analytics 1100 may cause data gathering module 1194 to gather data from one or more data sources 1110 and send the data to behavioral based analytics 1100. Behavioral based analytics 1100 may determine updated incentives as described above and store the incentives in data store 1122. In some embodiments, behavioral based analytics 1100 may use some or all of the previously computed incentives and/or previously gathered data in determining incentive updates. In another embodiment, the previously computed incentives or previously gathered data is not used in re-computing incentives or determining incentive updates.

Behavioral based analytics 1100 may also update incentives as data is received from data gathering module 1194. In some embodiments, receipt of data from one or more data sources 1110 by data gathering module 1194 or behavioral based analytics component 1100 may be used as trigger 1130. Once incentives have been re-computed, adjusted, updated, or otherwise determined, the resulting incentives are stored in data store 1122.

FIG. 12A illustrates one embodiment of a web interface 1200 for a vehicle data system that allows a user to search vehicle data by make and make/model (area 1202). In this example, the web interface 1200 may be provided by a trusted affiliate website. Furthermore, in this example, several manufacturers have defined incentives 1202 that are provided to users who access the vehicle data system via the trusted affiliate web site.

Using the search functionality provided by interface 1200 a user may search by manufacturer or manufacturer and model. Say, for example, the user selects to search Dodge Challenger (e.g., the user selects Dodge in manufacturer search box 1204 and Challenger in model search box 1206), the user may be presented with an updated web page 1210 illustrated in FIG. 12B which can display a targeted incentive 1212. Targeted incentive 1212 may be presented to the user based on searching Dodge:Challenger directly. Had the user simply searched “Dodge” in interface 1200 and then selected the Challenger from the search results or browsed to another Dodge vehicle first, the user may have been presented with a different (or no) targeted incentive for the Dodge Challenger. In the example of FIG. 12B, however, the user is presented with incentive 1212 because an observable feature or combination of observable features matched the user segment associated with incentive 1212 for the Dodge Challenger.

According to one embodiment, incentive 1212 includes a unique code 1214 generated for that incentive and the unique code can be stored by the vehicle data system in association with the incentive and user. The user may present the incentive certificate or code 1212 to a dealer when closing a vehicle purchase. The dealer can provide the unique code 1214 and user information (e.g., name or information) to the vehicle data system (e.g., via a dealer portal) to verify the code prior to closing a sale.

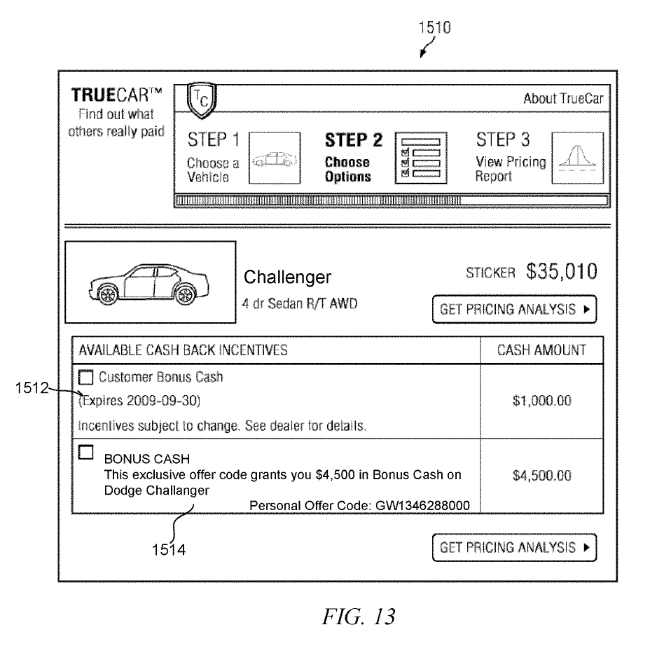

FIG. 13 illustrates one embodiment a web interface 1510 for a vehicle data system after the user has selected to view the Dodge Challenger. In this example, the user is presented with a non-targeted incentive 1512 that may be available to every user and a targeted incentive 1514. The targeted incentive 1514 may have been provided to the user because, for example, the user had recently view a competitive vehicle via the vehicle data system. If the user selects the targeted incentive 1514, the targeted incentive amount may be used in determining vehicle pricing data, including adjusting upfront pricing provided by a dealer. Again, the dealer may verify the personal offer code before closing a purchase.

Although this disclosure makes reference to vehicles or automobiles, one skilled in the art would recognize that the systems and methods described herein may be used for any product or service.

Although the invention has been described with respect to specific embodiments herein, these embodiments are merely illustrative, and not restrictive of the disclosure. The description herein of representative embodiments of the invention, including the description in the Abstract and Summary, is not intended to be exhaustive or to limit the disclosure to the precise forms described herein (and in particular, the inclusion of any particular embodiment, feature or function within the Abstract or Summary is not intended to limit the scope of the disclosure to such embodiment, feature or function). Rather, the description is intended to describe illustrative embodiments, features and functions in order to provide a person of ordinary skill in the art context to understand the disclosure without limiting the disclosure to any particularly embodiment, feature or function, including any such embodiment feature or function described in the Abstract or Summary. While specific embodiments of, and examples for, are described herein for illustrative purposes, various substantially equivalent modifications are possible within the spirit and scope of the disclosure, as those skilled in the relevant art will recognize and appreciate. As indicated, such modifications may be made to the disclosure in view of the foregoing description of representative embodiments and are to be included within the spirit and scope of the disclosure. Thus, while various representative embodiments have been described herein, a latitude of modification, various changes and substitutions are intended for inclusion in the disclosure, and it will be appreciated that in some instances some features of various representative embodiments may be employed without corresponding use of other features without departing from the scope and spirit of the disclosure as set forth herein. Therefore, many modifications may be made to adapt a particular situation or material to the essential scope and spirit of the disclosure.

Reference throughout this specification to “one embodiment”, “an embodiment”, or “a specific embodiment” or contextual variants thereof, means that a particular feature, structure, or characteristic described in connection with the subject embodiment is included in at least one embodiment and may not necessarily be present in all embodiments. Accordingly, respective appearances of the phrases “in one embodiment”, “in an embodiment”, or “in a specific embodiment” or contextual variants thereof, in various places throughout this specification, are not necessarily referring to the same or even related embodiments. Furthermore, the particular features, structures, or characteristics of any particular embodiment may be combined in any suitable manner with one or more other embodiments. It will be understood that other variations and modifications of the representative embodiments described and illustrated herein are possible in light of the teachings herein and are to be considered as part of the spirit and scope of the disclosure.

In the description herein, numerous specific details are provided, such as examples of components and/or methods, to provide a thorough understanding of various representative embodiments. One skilled in the relevant art will recognize, however, that a particular embodiment may be able to be practiced without one or more of the specific details recited, or with other apparatuses, systems, assemblies, methods, components, materials, parts, and/or the like. In other instances, well-known structures, components, systems, materials, or operations are not specifically shown or described in detail to avoid unnecessarily obscuring aspects of embodiments of the invention. While the invention may be illustrated with respect to a particular embodiment, this is not and does not limit the invention to any specific embodiment, and a person of ordinary skill in the art will recognize that additional embodiments are readily understandable and contemplated and included in this disclosure.

Representative embodiments discussed herein may be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices may include a keyboard, monitor, printer, electronic pointing device (for example, mouse, trackball, stylus, touch pad, etc.), and/or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor, whether now known or hereafter derived in the art. For example, a computer-readable medium may refer to a data cartridge, a data backup magnetic tape, a floppy diskette, a flash memory drive, an optical data storage drive, a CD-ROM, ROM, RAM, HD, and/or the like. The processes described herein may be implemented in suitable computer-executable instructions that may reside on a computer readable medium (for example, a disk, CD-ROM, a memory, etc.). Alternatively, conjunctively or sequentially, computer-executable instructions may be stored as software code components on a direct access storage device array, magnetic tape, floppy diskette, optical storage device, and/or other appropriate computer-readable medium or storage device.

A suitable language may be used, individually or in conjunction with another programming language, to implement the routines, methods or programs of various representative embodiments described herein, including C, C++, Java, JavaScript, HTML, or any other programming or scripting language, etc. Other software/hardware/network architectures may be used. For example, the functions of variously disclosed embodiments may be implemented on one computer or shared/distributed among two or more computers in or across a network. Communications between computers implementing representative embodiments can be accomplished using any electronic, optical, radio frequency signals, or other suitable methods and/or tools of communication in compliance with known network protocols.

Different programming techniques may be employed such as procedural or object oriented. Any particular routine can execute on a single computer processing device or multiple computer processing devices, a single computer processor or multiple computer processors. Data may be stored in a single storage medium or distributed through multiple storage media, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative or conjunctive embodiments may be performed at substantially the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein may be implemented in the form of control logic in software or hardware or a combination of both. Control logic may be stored in an information storage medium, such as a computer-readable medium, as a plurality of instructions adapted to direct an information-processing device to perform a set of steps disclosed in the various embodiments. Based on the disclosure and teachings provided herein, a person of ordinary skill in the art will appreciate other ways and/or methods to implement various embodiments disclosed herein.

It is also within the spirit and scope of the invention to implement, in software programming or code, any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented using software programming or code in one or more digital computers, by using application specific integrated circuits, programmable logic devices, field programmable gate arrays; optical, chemical, biological, quantum or nanoengineered systems, components and mechanisms may be alternatively, conjunctively or sequentially used. In general, various functions of disclosed representative embodiments can be achieved by any means now known or hereafter derived in the art; for example, distributed or networked systems, components and circuits may be used. In another example, communication or transfer (or otherwise moving from one place to another) of data may be wired, wireless, or by any other means.

A “computer-readable medium” may be any medium that can store the program for use by or in connection with the instruction execution system, apparatus, system or device. The computer readable medium can be, by way of example, but not limited to, an electronic, magnetic, optical, electromagnetic, infrared, or semiconductor system, apparatus, system, device, or computer memory. Such computer-readable media are machine-readable and include software programming or code that can be human readable (e.g., source code) or machine readable (e.g., object code). Examples of non-transitory computer-readable media may include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art will appreciate, a computer program product implementing various embodiments disclosed herein may comprise one or more non-transitory computer readable media storing computer instructions translatable by one or more processors in a computing environment.

A “processor” includes any hardware system, mechanism or component that processes data, signals or other information. A processor may include a system with a central processing unit, an application-specific processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing may be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other contextual variant thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

What is claimed is:

1. A data system comprising:
a targeted incentive database mapping product categories to targeted incentive levels and mapping the targeted incentive levels to a plurality of user segments corresponding to observable features of users;
a processor;
a non-transitory computer readable medium storing instructions that are translatable by the processor to perform:
providing an interface for an online product search service;
receiving a user query from a user computer device, the query comprising product configuration information;
collecting a set of observable features associated with the user;
determining a user segment for the user, determining the user segment comprising applying a set of segment matching rules to match the user to a user segment from the targeted incentive database based on the set of observable features associated with the user;
identifying a targeted incentive level for a product category from a plurality of targeted incentive levels for the product category according to a mapping in the targeted incentive database between the determined user segment and the identified targeted incentive level; and
generating a responsive web page to display the identified targeted incentive level at the user computing device.

2. The system of claim 1, further comprising instructions translatable to perform:
recording user behavior with the online product search service in a usage log containing activities associated with the user, wherein the set of observable features associated with the user comprises the user behavior.

3. The system of claim 2, wherein the user behavior comprises a sequence of search queries made and items viewed.

4. The system of claim 1, further comprising instructions translatable by the processor to perform:
defining a first user segment based on a first type of user behavior;
defining a second user segment based on a second type of user behavior;
associating a first incentive level for the product category with the first user segment; and
associating the second incentive level for the product category with the second segment, wherein the first type of user behavior and second type of user behavior represent different levels of searching.

5. The system of claim 1, wherein the query is received over a network in association with a set of user-specified vehicle attributes, the query including one or more of the set of observable features.

6. The system of claim 1, wherein generating a responsive web page to display the identified targeted incentive level at the user computing device comprises generating an incentive certificate for a first brand.

7. The system of claim 6, further comprising instructions translatable by the processor to perform:
generating an incentive code for the identified incentive level and including the incentive code in the incentive certificate.

8. The system of claim 7, further comprising instructions translatable by the processor to perform:
receiving the incentive code and user information from a dealer system; and
verifying the incentive code to the dealer system.

9. The system of claim 1, further comprising instructions translatable by the processor to perform:
obtaining a set of historical data from a plurality of data sources;
identifying a first vehicle model and a set of competitive vehicle models;
developing a demand model for the first vehicle model based on a multivariable analysis of a set of vehicle pricing data, vehicle incentive data, and historical transaction records, the demand model defining demand as function of first vehicle model price and vehicle model prices of vehicle models in the set of competitive vehicle models;
determining a price elasticity of demand for the first vehicle model based on determining a change in demand for a change in a first vehicle model price using the demand model;
applying the price elasticity of demand for the first vehicle model to a first set of incremental changes in the first vehicle model price to determine the demand response for the first set of incremental changes in the first vehicle model price, the first set of incremental changes in the first vehicle model price corresponding to a first set of incentive amounts applied to the first vehicle model price; and
persisting a first set of incentive levels for the first vehicle model in the targeted incentive database, the first set of incentive levels associated with the plurality of incentive amounts.

10. The system of claim 9, further comprising instructions translatable by the processor to perform:
determining a cross price elasticity of demand for the first vehicle model based on determining a change in demand for a change in a second vehicle model price using the demand model, the second vehicle model selected from the set of competitive vehicle models; and
applying the cross price elasticity of demand for the first vehicle model to a set of incremental changes in a second vehicle model price to determine the demand response for the set of incremental changes in the second vehicle model price, the set of incremental changes in the second vehicle model price corresponding to a plurality of incentive amounts applied to the second vehicle model price.

11. The system of claim 9 further comprising instructions translatable to perform:
determining a set of user segments based on similarities between user features;
for a selected segment from the set of user segments, determining a segment specific demand response for the for a second set of incremental changes in the first vehicle model price, the second set of incremental changes in the first vehicle model price corresponding to a second set of incentive amounts applied to the first vehicle model price; and
persisting at least one incentive level for the first vehicle, the at least one incentive level associated with the selected segment and at least one of the second set of incentive amounts.

12. A system comprising:
one or more computing devices;
a targeted incentive database mapping product categories to targeted incentive levels and mapping the targeted incentive levels to a plurality of user segments corresponding to observable features of users;
a vehicle data system embodiment on a server machine communicatively connected to the one or more computing devices via a network, the vehicle data system comprising a processor and a non-transitory computer readable medium storing instructions that are translatable by the processor to perform:
providing an interface for an online vehicle search service;
receiving a user query from a user computer device, the query comprising vehicle configuration information;
collecting a set of observable features associated with the user;
determining a user segment for the user, determining the user segment comprising applying a set of segment matching rules to match the user to a user segment from the targeted incentive database based on the set of observable features associated with the user;
identifying a targeted incentive level for a vehicle category from a plurality of targeted incentive levels for the vehicle category according to a mapping in the targeted incentive database between the determined user segment and the identified targeted incentive level; and
generating a responsive web page to display the identified targeted incentive level at the user computing device.

13. The system of claim 12, further comprising instructions translatable to perform:
recording user behavior with the online product search service in a usage log containing activities associated with the user, wherein the set of observable features associated with the user comprises the user behavior.

14. The system of claim 13, wherein the user behavior comprises a sequence of search queries made and items viewed.

15. The system of claim 12, further comprising instructions translatable by the processor to perform:
defining a first user segment based on a first type of user behavior;
defining a second user segment based on a second type of user behavior;
associating a first incentive level for the vehicle category with the first user segment; and
associating a second incentive level for the vehicle category with the second user segment, wherein the first type of user behavior and second type of user behavior represent different levels of searching.

16. The system of claim 12, wherein the query is received over the network in association with a set of user-specified vehicle attributes, the query including one or more of the set of observable features.

17. The system of claim 12, wherein generating a responsive web page to display the identified targeted incentive level at the user computing device comprises generating an incentive certificate for a first brand.

18. The system of claim 17, further comprising instructions translatable by the processor to perform:
generating an incentive code for the identified incentive level and including the incentive code in the incentive certificate.

19. The system of claim 18, further comprising instructions translatable by the processor to perform:
receiving the incentive code and user information from a dealer system; and
verifying the incentive code to the dealer system.

20. The system of claim 12, further comprising instructions translatable by the processor to perform:
obtaining a set of historical data from a plurality of data sources;
identifying a first vehicle model and a set of competitive vehicle models;
developing a demand model for the first vehicle model based on a multivariable analysis of a set of vehicle pricing data, vehicle incentive data, and historical transaction records, the demand model defining demand as function of first vehicle model price and vehicle model prices of vehicle models in the set of competitive vehicle models;
determining a price elasticity of demand for the first vehicle model based on determining a change in demand for a change in a first vehicle model price using the demand model;
applying the price elasticity of demand for the first vehicle model to a first set of incremental changes in the first vehicle model price to determine the demand response for the first set of incremental changes in the first vehicle model price, the first set of incremental changes in the first vehicle model price corresponding to a first set of incentive amounts applied to the first vehicle model price; and
persisting a first set of incentive levels for the first vehicle model in the targeted incentive database, the first set of incentive levels associated with the plurality of incentive amounts.

21. The system of claim 20, further comprising instructions translatable by the processor to perform:
determining a cross price elasticity of demand for the first vehicle model based on determining a change in demand for a change in a second vehicle model price using the demand model, the second vehicle model selected from the set of competitive vehicle models; and
applying the cross price elasticity of demand for the first vehicle model to a set of incremental changes in a second vehicle model price to determine the demand response for the set of incremental changes in the second vehicle model price, the set of incremental changes in the second vehicle model price corresponding to a plurality of incentive amounts applied to the second vehicle model price.

22. The system of claim 20 further comprising instructions translatable to perform:
determining a set of user segments based on similarities between user features;
for a selected segment from the set of user segments, determining a segment specific demand response for the for a second set of incremental changes in the first vehicle model price, the second set of incremental changes in the first vehicle model price corresponding to a second set of incentive amounts applied to the first vehicle model price; and
persisting at least one incentive level for the first vehicle, the at least one incentive level associated with the selected segment and at least one of the second set of incentive amounts.
